(19) United States
(12) Patent Application Publication
(10) Pub. No.: US 2025/0137637 A1
(43) Pub. Date: May 1, 2025

(54) System and Method for Combusting High-Moisture Fuel to Generate Steam

(71) Applicant: Air Products and Chemicals, Inc., Allentown, PA (US)

(72) Inventor: Mark Daniel D'Agostini, Allentown, PA (US)

(73) Assignee: Air Products and Chemicals, Inc., Allentown, PA (US)

(21) Appl. No.: 18/499,636

(22) Filed: Nov. 1, 2023

(51) Int. Cl. F22B 31/08; F22B 35/00

(52) U.S. Cl. CPC F22B 31/08; F22B 35/002

(57) ABSTRACT

A process for combusting a high-moisture fuel to generate steam, the process comprising heating a high-moisture solid fuel while contacting the high-moisture solid fuel with an oxygen-depleted gas stream to produce a dried solid fuel and a moist oxygen-depleted gas stream; combusting the dried solid fuel with a combustion air stream to produce a combustion products stream; transferring heat to generate steam by indirect heat exchange with the combustion products stream; dividing the combustion products stream into a first portion and a second portion; transferring heat to the recirculating thermal fluid by indirect heat exchange with the first portion of the combustion products stream; and transferring heat to preheat the combustion air stream by indirect heat exchange with the second portion of the combustion products stream; and recombining the first portion of combustion products stream and the second portion of the combustion products stream.

### BACKGROUND

The efficient use of biomass, low-rank coal and other solid fuels in reaction vessels such as steam generating boilers, process heating/melting furnaces and gasifiers is often limited by the high moisture content of the fuel. In boilers, high fuel moisture levels suppress the flame temperature leading to reduced boiler radiant heat transfer rate, poor fuel utilization (high unburned carbon levels) and, ultimately, to steam generation capacity that is below design expectations. Moreover, high fuel moisture leads to extremely large flue gas volume flows and low boiler efficiency due to loss of latent heat in the exhaust gases leaving the stack.

Combustion can be made more efficient via the direct or indirect injection of a gas having an oxygen concentration higher than the 20.9% in ambient air. The primary benefits include increasing both the flame temperature (leading to higher rates of radiation heat transfer) and the rate of combustion kinetics (further leading to higher combustion efficiency), as well as reducing the flow rate of combustion air required, leading to lower flow rate of the products of combustion. For a given sized of boiler, this enables higher fuel throughput and steam and/or power generation.

A cost-effective, safe and technically sound means of reducing fuel moisture is therefore needed to improve boiler efficiency and increase steam generation rate, thereby dramatically reducing the cost of steam generation and electric power production. Since fuel moisture levels are subject to change with seasonal ambient conditions and changes in fuel supply, the system should offer broad operational flexibility to enable optimization as circumstances vary.

### SUMMARY

This invention relates to a process to generate steam from a high-moisture, low-BTU solid fuel. The process thermally integrates a dryer with a boiler where the combustion products stream leaving the boiler provides process heat in the form of a recirculating thermal fluid to dry the wet fuel while an inert atmosphere ensures safe operation of the dryer. Efficiency may be further improved by oxygen enrichment on the combustion air used in the boiler. The degree of oxygen enrichment may be used to control the operation of the steam generator.

Aspect 1: A process for combusting a high-moisture fuel to generate steam, the process comprising heating a high-moisture solid fuel while contacting the high-moisture solid fuel with an oxygen-depleted gas stream to produce a dried solid fuel and a moist oxygen-depleted gas stream; combusting the dried solid fuel with a combustion air stream to produce a combustion products stream; transferring heat to generate steam by indirect heat exchange with the combustion products stream; dividing the combustion products stream into a first portion and a second portion; transferring heat to the recirculating thermal fluid by indirect heat exchange with the first portion of the combustion products stream; and transferring heat to preheat the combustion air stream by indirect heat exchange with the second portion of the combustion products stream; and recombining the first portion of combustion products stream and the second portion of the combustion products stream.

Aspect 2: A process according to Aspect 1, wherein a diverter controls the flow rates of the first and second portions of the combustion products stream.

Aspect 3: A process according to Aspect 1 or Aspect 2, further comprising adding an oxygen-enriched stream to the combustion air stream prior to combusting the dried solid fuel; and controlling one or both of a flow rate of the oxygen-enriched stream and a location of adding the oxygen-enriched stream to control one or more of the following properties: steam temperature, steam pressure, steam drum level, stoker grate temperature, temperature of the combustion products stream prior to transferring the first portion of the amount of heat to generate steam, temperature of the combustion products stream after transferring the first portion of the amount of heat to generate steam, temperature of the combustion products stream after transferring the second portion of the amount of heat to the recirculating thermal fluid, temperature of the combustion products stream after transferring the third portion of the amount of heat to preheat the combustion air, temperature of the moist oxygen-depleted gas stream, temperature of the dried solid fuel, moisture level of the high-moisture solid fuel, and moisture level of the dried solid fuel.

Aspect 4: A process according to any of Aspects 1 to 3, further comprising transferring heat from the recirculating thermal fluid to the oxygen depleted gas stream before it contacts the high moisture solid fuel to produce a heated oxygen depleted gas stream.

Aspect 5: A process according to Aspect 4, wherein the heated oxygen-depleted gas stream is contacted with the high-moisture solid fuel within a screw conveyor.

Aspect 6: A process according to Aspect 5, wherein the screw conveyor comprises a hollow rotating shaft with one or more holes; and wherein the heated oxygen-depleted gas stream passes radially outward through the one or more holes to contact the high-moisture solid fuel.

Aspect 7: A process according to any of Aspects 1 to 6, wherein the high-moisture solid fuel is contacted with the oxygen-depleted gas stream while heating the high-moisture solid fuel by indirect heat exchange with the recirculating thermal fluid to produce the dried solid fuel and the moist oxygen-depleted gas stream.

Aspect 8: An apparatus for generating steam comprising a dryer configured and arranged to create contact between a high-moisture solid fuel and an oxygen-depleted gas stream and to produce a dried solid fuel; a combustion air system having an air inlet for receiving air and a combustion air outlet for discharging the combustion air stream; a boiler comprising a furnace section, a convective section, and an energy recovery section, the furnace section being configured to receive the dried solid fuel from the dryer and the combustion air stream from the combustion air system, and to combust the dried solid fuel with a combustion air stream to produce a combustion products stream, and transferring heat from the combustion products stream to boil water principally by thermal radiation, the convective section having one or more heat exchangers in fluid flow communication with the furnace section for transferring heat to boil water principally by convection heating, and the energy recovery section comprising a diverter configured to divide the flow of the combustion products stream between a first flue path and a second flue path, wherein the first flue path comprises an air preheater for preheating the combustion air stream by indirect heat exchange with a portion of the combustion products stream, and wherein the second flue path comprises an auxiliary heat exchanger for heating a first heat transfer fluid.

Aspect 9: An apparatus according to Aspect 8, the dryer having an inlet section and an outlet section, the inlet section including a high-moisture solid fuel inlet, an oxygen-depleted stream inlet, and a recirculating thermal fluid outlet; the outlet section including a high-moisture solid fuel outlet, an oxygen-depleted stream outlet, and a recirculating thermal fluid inlet.

Aspect 10: An apparatus according to Aspect 8 or Aspect 9, the combustion air system further having an oxygen inlet for receiving oxygen and one or more oxygen control valves to enable controlled oxygen enrichment of the combustion air stream upstream of the combustion air outlet.

Aspect 11: An apparatus according to any of Aspects 8 to 10, wherein the dryer comprises a screw conveyor comprising a high-moisture solid fuel inlet, and a hollow screw shaft fitted with a helical screw flight configured to push the high-moisture solid fuel along the length of the screw conveyor; a blanketing gas preheater configured to indirectly transfer heat from the first heat transfer fluid to the oxygen-depleted gas stream to produce a heated oxygen-depleted gas stream; wherein the hollow screw shaft comprises one or more holes in fluid flow communication with the heated oxygen-depleted gas stream.

Aspect 12: A system for drying a high-moisture solid fuel comprising a screw conveyor comprising a high-moisture solid fuel inlet, and a hollow screw shaft fitted with a helical screw flight configured to push the high-moisture solid fuel along the length of the screw conveyor; wherein the hollow screw shaft comprises one or more holes in fluid flow communication with a source of blanketing gas.

Aspect 13: A system according to Aspect 12, further comprising a combustion air system having an air inlet for receiving air and a combustion air outlet for discharging a combustion air stream; a boiler comprising a furnace section, a convective section, and an energy recovery section, the furnace section being configured to receive the dried solid fuel from the screw conveyor and the combustion air stream from the combustion air system, and to combust the dried solid fuel with the combustion air stream to produce a combustion products stream, and transferring heat to boil water principally by thermal radiation, the convective section having an auxiliary heat exchanger in fluid flow communication with the furnace section for transferring heat from the combustion products stream to boil water, and the energy recovery section comprising an air preheater for preheating the combustion air stream by indirect heat exchange with the combustion products stream, and an auxiliary heat exchanger for heating a first heat transfer fluid.

Aspect 14: A system according to Aspect 13, wherein the screw conveyor comprises a heat exchanger in fluid flow communication with the auxiliary heat exchanger.

Aspect 15: A system according to Aspect 13 or Aspect 14, further comprising a blanketing gas preheater for preheating the blanketing gas by indirect heat exchange with the first heat transfer fluid.

Aspect 16: A system according to any of Aspects 13 to 15, wherein the energy recovery section comprises a diverter upstream of the air preheater and the auxiliary heat exchanger, the diverter configured to divide the flow of the combustion products stream between a first flue path comprising the air preheater and a second flue path comprising the auxiliary heat exchanger.

### BRIEF DESCRIPTION OF THE DRAWINGS

The present invention will hereinafter be described in conjunction with the appended figures wherein like numerals denote like elements:

FIG. 1 is a flowsheet schematic depicting a prior art steam generation process.

FIG. 2 is a flowsheet schematic depicting an embodiment of a steam generation process in which the fuel is first dried using a recirculating thermal fluid that is heated by the combustion products.

FIG. 3 is a flowsheet schematic depicting a modification of the embodiment of FIG. 2 in which the level of oxygen enrichment is increased or decreased to control the combustion properties of the boiler and/or the conditions in the steam generator.

FIG. 3A is a flowsheet schematic depicting a modification of the embodiment of FIG. 4 in which conditions in the boiler are used to increase or decrease the amount of oxygen enrichment and/or combustion air bypass flow rate.

FIG. 4 is a flowsheet schematic depicting a modification of the embodiment of FIG. 3 in which the flow rate of the combustion products bypass stream is increased or decreased to control the amount of water removed from the wet solid fuel in the dryer by increasing or decreasing the amount of heat that can be transferred to the recirculating thermal fluid.

FIG. 4A is a flowsheet schematic depicting a modification of the embodiment of FIG. 4 in which conditions in the boiler are used to increase or decrease the amount of oxygen enrichment and/or combustion products bypass flow rate.

FIG. 5 is a flowsheet schematic depicting a modification of the embodiment of FIG. 3 in which the fuel is dried by an oxygen-depleted gas stream that has been heated by the combustion products.

FIG. 6 is a flowsheet schematic depicting a modification of the embodiment of FIG. 5 in which the oxygen-depleted gas stream forms a closed loop by introducing a particulate removal system, condenser, and blower.

FIG. 7 is a flowsheet schematic depicting a modification of the embodiment of FIG. 5 in which the heating duty for the oxygen-depleted gas stream is transferred from the combustion products by a thermal recirculating fluid.

FIG. 8 is a flowsheet schematic depicting a modification of the embodiment of FIG. 6 in which the heating duty for the oxygen-depleted gas stream is transferred from the combustion products by a thermal recirculating fluid.

FIG. 9A is a cross-section showing an embodiment of a fuel dryer in which a recirculating fluid flows through an annular space in a double-walled vessel.

FIG. 9B is a cross-section showing an embodiment of a fuel dryer in which a recirculating fluid flows through pipes that pass through the dryer.

FIG. 10 is a flowsheet schematic depicting a modification of the embodiment of FIG. 2 in which the positions of an air preheater and an auxiliary heat exchanger are switched.

FIG. 11 is a flowsheet schematic depicting a modification of the embodiment of FIG. 2 in which the air preheater is eliminated.

FIG. 12 is a flowsheet schematic depicting a modification of the embodiment of FIG. 2 in which a blanketing gas preheater allows direct heat transfer to the wet solid fuel.

FIG. 13 is a flowsheet schematic depicting a modification of the embodiment of FIG. 10 in which a blanketing gas preheater allows direct heat transfer to the wet solid fuel.

FIG. 14 is a flowsheet schematic depicting a modification of the embodiment of FIG. 11 in which a blanketing gas preheater allows direct heat transfer to the wet solid fuel.

FIG. 15A is a cross-section showing an embodiment of a screw conveyor for drying a solid fuel.

FIG. 15B is an external view of an embodiment of a screw conveyor for drying a solid fuel.

FIG. 16 is a flowsheet schematic showing a section of the flue gas duct modified to place the air preheater and auxiliary heat exchanger in parallel.

FIG. 17 is a flowsheet schematic depicting a modification of the embodiment of FIG. 16 in which a blanketing gas preheater allows direct heat transfer to the wet solid fuel.

FIG. 18 is a graph showing the relationship between dryer outlet temperature and the amount of water vapor in a nitrogen stream.

FIG. 19 is a schematic diagram showing the counter-current and co-current flow patterns in the fuel dryer.

FIG. 20 is a graph showing boiler efficiency as a function of as-fired fuel moisture for Example 2.

FIG. 21 is a graph showing flame temperature as a function of as-fired fuel moisture for Example 2.

FIG. 22 is a graph showing flue gas flow rate as a function of as-fired fuel moisture for Example 2.

FIG. 23 is a graph showing steam flow rate as a function of as-fired fuel moisture for Example 2.

FIG. 24 is a graph showing boiler efficiency as a function of oxygen enrichment level for Example 3.

FIG. 25 is a graph showing flame temperature as a function of as-fired fuel moisture for Example 3.

FIG. 26 is a graph showing flue gas flow rate as a function of as-fired fuel moisture for Example 3.

FIG. 27 is a graph showing steam flow rate as a function of as-fired fuel moisture for Example 3.

### DETAILED DESCRIPTION

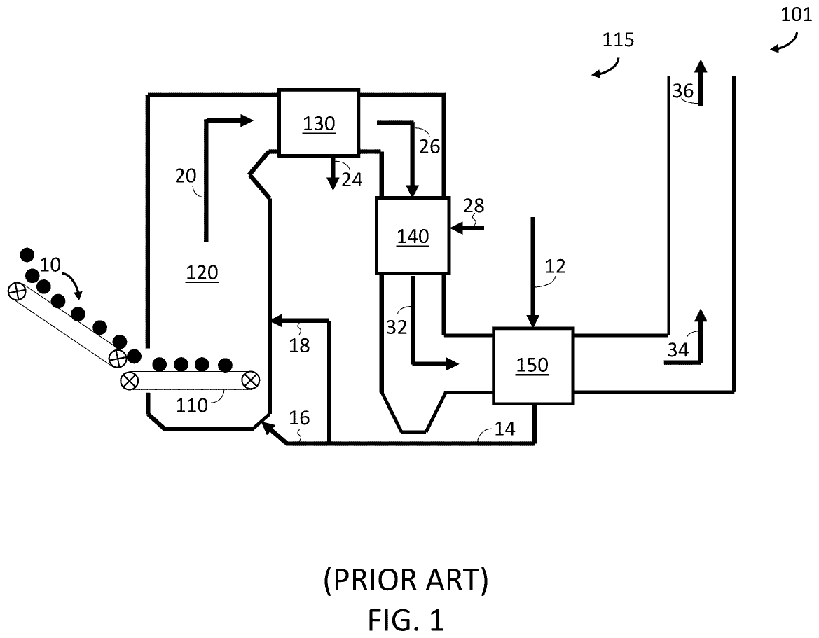

FIG. 1 shows a prior art embodiment a system 101 for combusting a solid fuel 10 to generate steam including boiler 115. The solid fuel 10 may have a high moisture content, in which case it would be high moisture solid fuel. The solid fuel 10 enters a furnace section 120 of the boiler 115 where radiant heat transfer dominates over convective heat transfer. The boiler 115 is depicted as a stoker, or grate-fired, boiler, which typically will have a grate 110 with holes sized to hold particles of the solid fuel 10 but still allow the passage of a primary combustion air stream 16 up through the grate 110 to facilitate combustion. The boiler 115 may otherwise be a fluidized bed boiler, cyclone boiler, pulverized fuel boiler or any other boiler configured to receive and efficiently combust the fuel particles 10.

An air stream 12 is preheated in an air preheater 150 to form a combustion airstream 14, which can then be divided into two or more streams as dictated by the geometry of the boiler. In the case of the stoker boiler 115 shown in FIG. 1, at least a portion of the combustion air stream 14 can be divided to form the primary combustion air stream 16 that enters below the grate 110 and provides the critical fast combustion reaction, and a secondary combustion air stream 18 that may be used above the grate 110 to improve combustion, in particular by oxidizing any volatile organic compounds or partially oxidized compounds like carbon monoxide. The combustion of the solid fuel 10 first provides heat to the furnace section 120 to convert water to steam, after which gaseous combustion products stream 20 having an amount of heat enters a convective section of the boiler 101, comprising a superheater 130 and an economizer 140. Finally, gaseous combustion products stream 32 enters an energy recovery section comprising an air preheater 150.

As used herein, the phrase “at least a portion” means “a portion or all.” The “at least a portion of a stream” has the same composition, with the same concentration of each of the species, as the stream from which it is derived.

The combustion products stream 20 enters the superheater 130, which is an indirect heat exchanger between the combustion products stream 20 and a water or saturated steam stream (not shown). The superheater 130 extracts heat from the combustion products stream 20 into the water or saturated steam stream to generate a superheated steam stream 24 by indirect heat exchange, while at the same time, converting the combustion products stream 30 into a first cooled combustion products stream 26 that has lost a portion of the amount of heat originally carried by the combustion products stream 20. Streams 20 and 26 have the same composition.

The term “indirect heat exchange” refers to the process of transferring sensible heat and/or latent heat between two or more fluids without the fluids in question coming into physical contact with one another. The heat may be transferred through the wall of a heat exchanger or with the use of an intermediate heat transfer fluid. As used herein, “first,” “second,” “third,” etc. are used to distinguish among a plurality of steps and/or features, and is not indicative of the total number, or relative position in time and/or space, unless expressly stated as such.

The first cooled combustion products stream 26 then enters the economizer 140 and indirectly transfers heat to a water stream 28 to form a heated water stream (not shown), which can then be used directly by downstream processes or heated further to produce more steam. At the same time, the economizer 140 converts the first cooled combustion products stream 26 into a second cooled combustion products stream 32 which has lost even more of the original amount of heat. But streams 20, 26, and 32 still all have the same composition.

The second cooled combustion products stream 32 then provides heat to the air preheater 150, as discussed above heating the air stream 12 to produce the combustion air stream 14, and leaving a third cooled combustion products stream 34 which then exits the flue as exhaust gas 36.

It will be appreciated by a person of skill in the art that FIG. 1 illustrates one type of steam generation process, but the general principles can be applied to any steam generation system in heating water by radiative and convective heat transfer to make saturated and/or supersaturated steam.

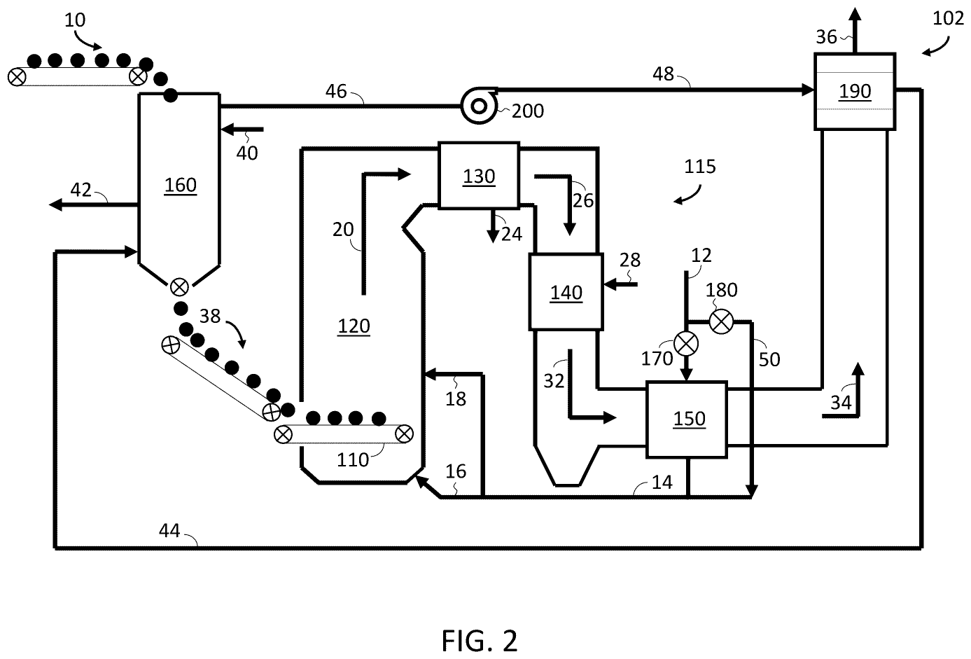

FIGS. 2 through 8 show various embodiments of systems specifically designed to handle high moisture solid fuels as an input, and to do so much more efficiently than the prior art system 101 discussed above with reference to FIG. 1.

FIG. 2 illustrates an embodiment of a system 102 that, in addition to the boiler 115, incorporates a dryer 160 configured to receive high moisture solid fuel 10 and discharge a dried solid fuel 38. The dryer 16—utilizes an oxygen-depleted blanketing gas 40 such as nitrogen, carbon dioxide, argon or any other suitable inert gas (i.e., a gas that does not promote an oxidizing reaction with the solid fuel 10), having oxygen concentration less than about 5 vol %, preferably less than about 3 vol %, more preferably less than about 1 vol % to extract moisture from the high moisture solid fuel 10. The blanketing gas 40 is injected into the dryer 160 where it contacts the high moisture solid fuel 10, suppressing fuel ignition while simultaneously removing moisture. After removal of moisture, the high moisture solid fuel 10 is converted to the dried solid fuel 38, which is then discharged from the dryer 160. A moist blanketing gas 42 then exits the dryer vessel and is subsequently vented to a safe location while the dried solid fuel 38 is delivered to the furnace section 120.

The low oxygen concentration of the blanketing gas 40 is essential as wet solid fuels are prone to decomposition reactions leading to self-heating and loss of chemical energy content as well as to off-gassing of combustible vapors. The low oxygen concentration is effective in both reducing the extent of decomposition reactions and preventing ignition of combustible off-gasses such as carbon monoxide and hydrocarbon vapors. The term “depleted” means having a lesser mole percent concentration of the indicated component than the original stream from which it was formed. “Depleted” does not mean that the stream is completely lacking the indicated component.

Preferrably, the blanketing gas 40 also has low water vapor concentration. This is because the low water vapor enables a larger amount of fuel moisture to be evaporated before saturation of the blanketing gas 40 is achieved. Moreover, the mass transfer rate of water vapor diffusion from the fuel surface to the blanketing gas 40 is proportional to the difference in water vapor partial pressure, P_{wat,fs}−P_{wat,bg}, where P_{wat,fs} is the water vapor partial pressure in equilibrium with the surface of the fuel and P_{wat,bg} is the water vapor partial pressure in the blanketing gas 40. Hence, as P_{wat,bg} is reduced, the rate of water vapor diffusion to the blanketing gas 40 is increased leading to higher amounts of fuel moisture removal per unit of vessel volume in the dryer 160. For those reasons the blanketing gas 40 may have a moisture content of less than 1 mol %, preferably less than 0.5 mol %.

The dryer 160 is heated by indirect heat exchange using a heated recirculating thermal fluid 44 which, after heating the dryer 160, leaves the dryer 160 as a cooled recirculating thermal fluid 46. A pump 200 is used to circulate the thermal fluid, taking in the cooled recirculating fluid 46 and discharging a pumped recirculating thermal fluid 48 which is heated in by indirect heat exchange in an auxiliary heat exchanger 190 by the third cooled combustion products stream 34, resulting in the exhaust stream 36 being even cooler than the third cooled combustion products stream 34. The design of the dryer 160 may be similar to that of a rotary kiln, a fluidized bed, one of a variety of motor-driven screws or conveyors, or other devices not explicitly mentioned herein. In FIG. 2 the energy recovery section further comprises the auxiliary heat exchanger 190.

In the embodiment of FIG. 2, the air preheater 150 is combined with a bypass system comprising an air preheater valve 170 and a combustion air bypass valve 180 that are configured to control a fraction of the air stream 12 that flows through the air preheater 150 and a remaining fraction of the air stream 12 that bypasses the air preheater 150 as a combustion air bypass stream 50. It will be appreciated that bypassing or diverting all or a portion of the air stream 12 around the air preheater 150 will result in a lower amount of heat transfer taking place between the second cooled combustion products stream 32 and the air stream 12 than if 100% of the air stream 12 passed through the heat exchanger of the air preheater 150 (i.e., zero bypass). Hence, bypassing a portion of the air stream 12 yields lower temperature combustion air 14 (i.e., 16, 18) entering the furnace section 120 and higher temperature in the third cooled combustion products stream 34 relative to the zero-bypass case. As a result, bypassing a portion of the air stream 12 would be expected to result in more heat transferred by to recirculating thermal fluid in the auxiliary heat exchanger 190, and thus more heat transferred to the dryer 160, reflecting a tradeoff between the amount of preheating provided to the combustion air 14 and relative dryness of the solid fuel 38.

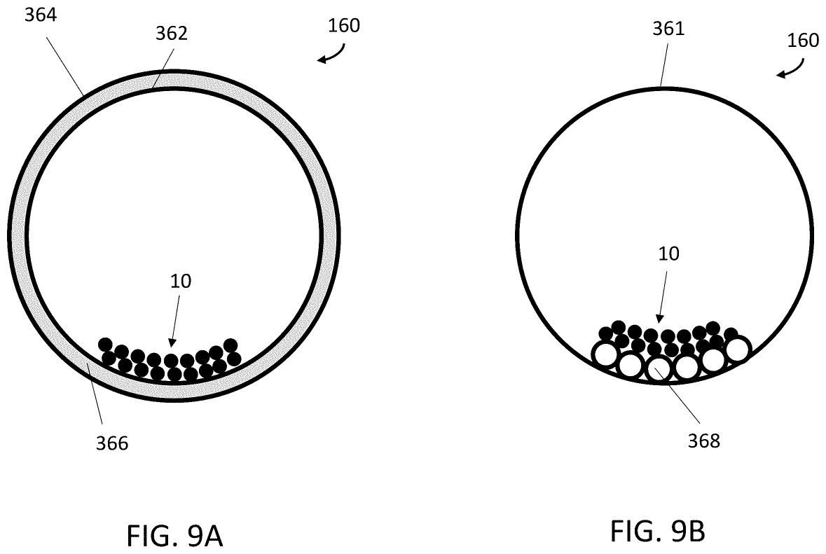

FIGS. 9A and 9B show cross sections which illustrate two possible embodiments for the plumbing of the dryer 160. The embodiment of FIG. 9A has a double wall dryer with an inner wall 362, and outer wall 364, and an annular space 366 between the walls 362 and 364 in which the recirculating thermal fluid 44 flows. The embodiment of FIG. 9B has a single-walled vessel 361 and heat transfer pipes 368 within the vessel 361 through which the recirculating thermal fluid 44 flows. While these two embodiments are exemplary, any configuration of the dryer 160 may be used that that allows indirect heat exchange to the contents of a vessel may be used.

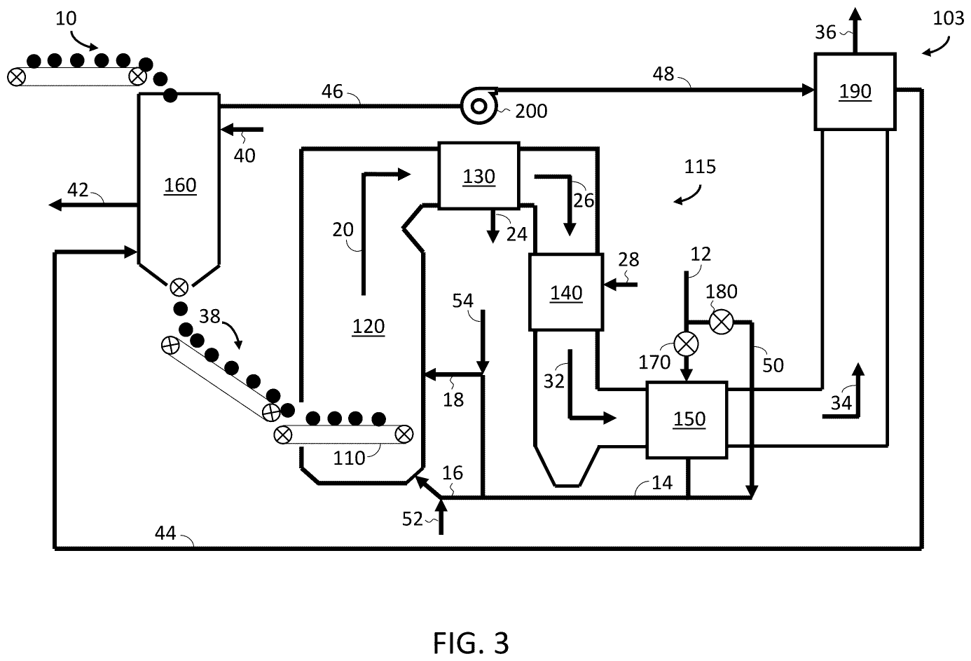

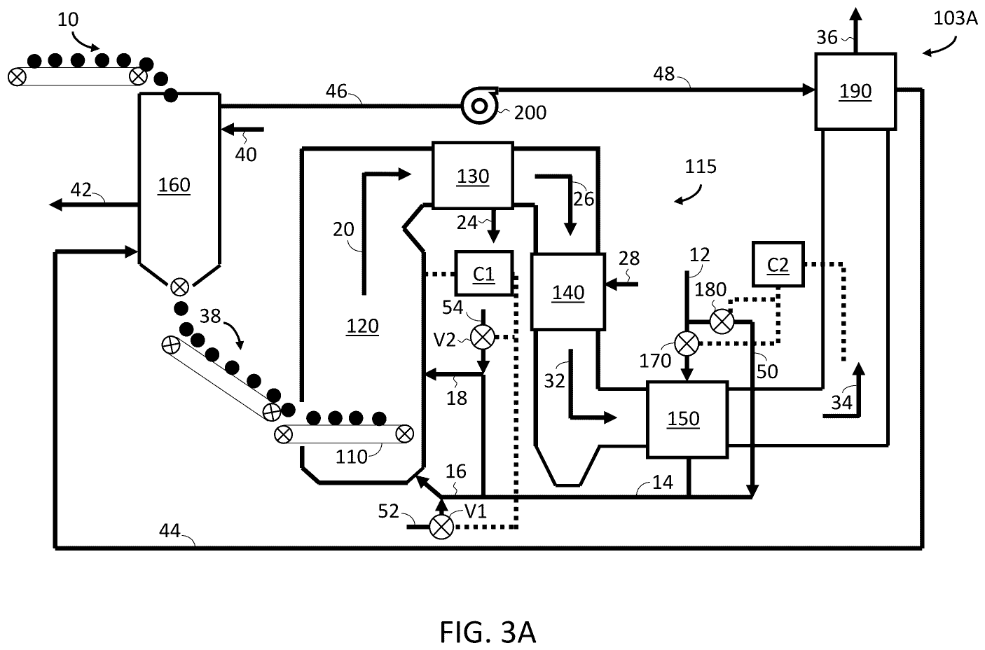

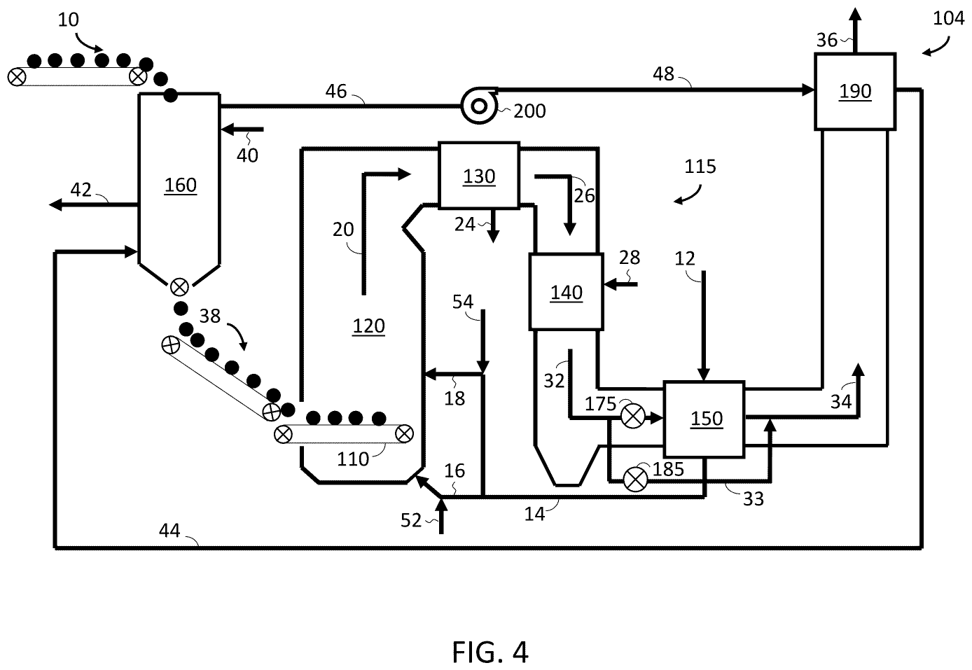

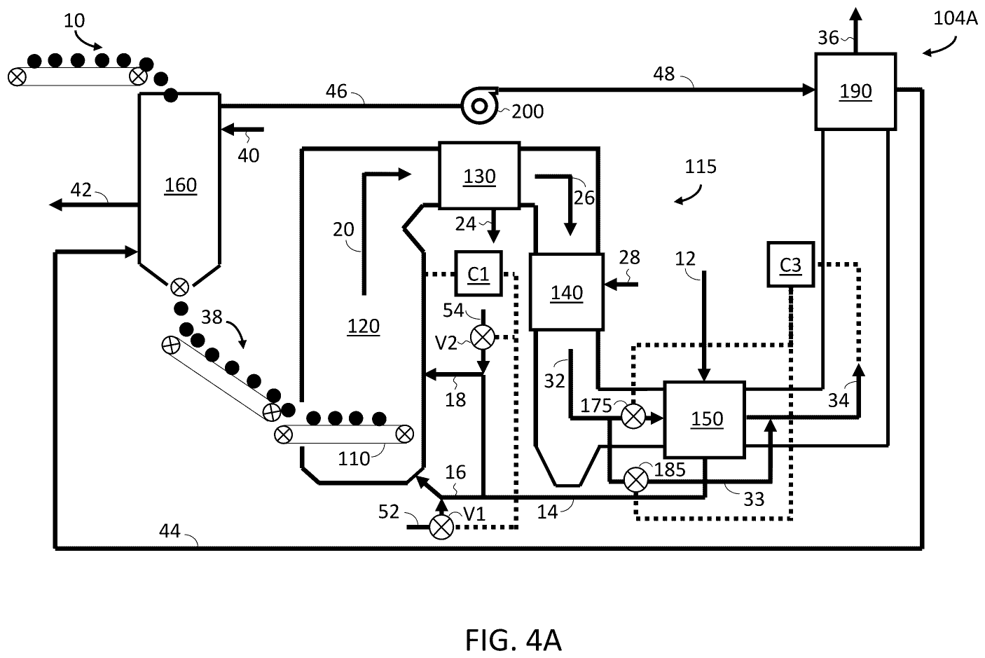

FIG. 3 illustrates an embodiment of a system 103 which, in addition to the features described in the system 102 of FIG. 2, further includes direct or indirect injection of a gas having an oxygen concentration of at least 30 vol %, preferably at least 80 vol % and most preferably 90 vol % or higher into the boiler 115 to promote oxygen-enriched combustion. The term “enriched” means having a greater mole percent concentration of the indicated component than the original stream from which it was formed. Indirect injection comprises oxygen introduction into one or more of the combustion air streams 16, 18 entering the boiler 115, while direct injection comprises an undiluted oxygen stream entering the boiler via a dedicated oxygen conduit (not shown). FIG. 4 shows indirect injection where a primary oxygen-enriched stream 52 is introduced with the primary combustion air stream 16 beneath the grate 110 and a secondary oxygen-enriched stream 54 is introduced with the secondary combustion air stream 18 above the grate 110. This allows independent control of oxygen enrichment for the primary combustion air stream 16 and secondary combustion air stream 18. An alternative embodiment could introduce a single oxygen-enriched stream into one or more of streams 12, 14, or 50.

FIG. 3A illustrates an embodiment of a system 103A with a controller C1 configured to increase or decrease the oxygen enrichment of the primary combustion air stream 16 and/or the secondary combustion stream 18. Any number of process variables may be monitored to control the level or location of oxygen enrichment, including steam temperature, steam pressure, boiler grate temperature, temperature of the combustion products stream 20, moisture content of the high-moisture solid fuel 10, and moisture content of the dried solid fuel 38. In FIG. 3A, the controller C1 receives electrical signals indicative of the variable(s) of interest. The controller C1 is programmed, based on those signals to control or adjust a flow rate of the primary oxygen-enriched stream 52 via a primary oxygen control valve V1 and/or a flow rate of the secondary oxygen-enriched stream 54 via a secondary oxygen control valve V2.

“Downstream” and “upstream” refer to an intended flow direction of a process fluid transferred. If the intended flow direction of the process fluid is from a first device to a second device, the second device is downstream of the first device. In case of a recycle stream, downstream and upstream refer to a first pass of the process fluid.

The system 103A of FIG. 3A also includes a controller C2 configured to increase or decrease a flow rate of the combustion air bypass stream 50. Any number of process variables may be monitored to control the combustion air bypass flow rate, including temperature of the second cooled combustion products stream 32, temperature of the third cooled combustion products stream 34, moisture content of the dried solid fuel 38, or moisture content of the moist blanketing gas 42. In the system 103A of FIG. 3A, the controller C2 receives an electrical signal indicative of the temperature of the third cooled combustion products stream 34. The controller C2 is programmed to use that signal to control a flow rate of the combustion air bypass stream 50 via the air preheater valve 170 and/or the combustion air bypass valve 180. In practice, the controllers C1 and C2 may be separate controllers or may be combined into a single controller with multiple control loops.

FIG. 4 illustrates an embodiment of a system 104 that is a variation of the system 103. In the system 104, a combustion products bypass stream 33 diverts a portion of the second cooled combustion products stream 32 to bypass around the air preheater 150. The portion of bypass flow is controlled by a combustion products valve 175 regulating a flow of the second cooled combustion products stream 32 and a combustion products bypass valve 185 regulating a flow of the combustion products bypass stream 33. It will be appreciated that this bypass of combustion products has the same effect as bypassing combustion air around the air preheater 150 by reducing air preheat temperature and increasing flue gas temperature downstream of the air preheater 150.

FIG. 4A illustrates an embodiment of a system 104A with a controller C3 configured to increase or decrease the flow rate of the combustion products bypass stream 33, and is a variation of the system 103A. Any number of properties may be monitored to control the combustion air bypass flow rate, including temperature of the second cooled combustion products stream 32, temperature of the third cooled combustion products stream 34, moisture content of the dried solid fuel 38, or moisture content of the moist blanketing gas 42. In the system 104A of FIG. 4A, the controller C3 receives an electrical signal indicative of the temperature of the third cooled combustion products stream 34. The controller C3 is programmed to use that signal to control a flow rate of the combustion products bypass stream 33 via the combustion products valve 175 and the combustion products bypass valve 185. In practice controllers C1 and C3 may be separate controllers or combined into a single controller with multiple control loops.

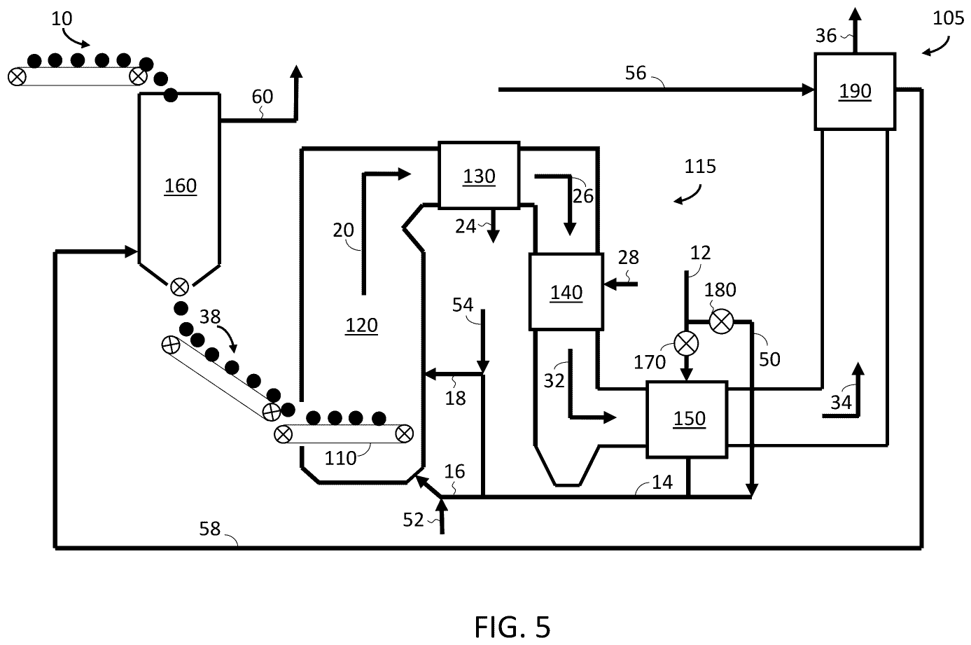

FIG. 5 shows an alternate system 105 that utilizes an inert gas as both a first heat transfer fluid and a blanketing gas. An inert gas 56 is indirectly heated in the auxiliary heater 190 against the third cooled combustion products stream 34 to produce a heated inert gas stream 58 and an exhaust stream 36 that is cooler that the third cooled combustion products stream 34. The heated inert gas stream 58 is then directly contacted with the high moisture solid fuel 10 in the dryer 160, carrying away the moisture as a moist inert gas stream 60 which leaves the dryer 160 and is vented. Oxygen enrichment via the primary oxygen-enriched stream 52 and/or the secondary oxygen-enriched stream 54 may optionally be included in the system 105.

The system 105 could be advantageous when a large quantity of relatively inert, dry gas is available at a reasonable cost. Such a circumstance may exist when a large air separation unit is required to produce oxygen to be used in the boiler 115 or other oxygen-intensive use and dry nitrogen is produced as a by-product or off-gas.

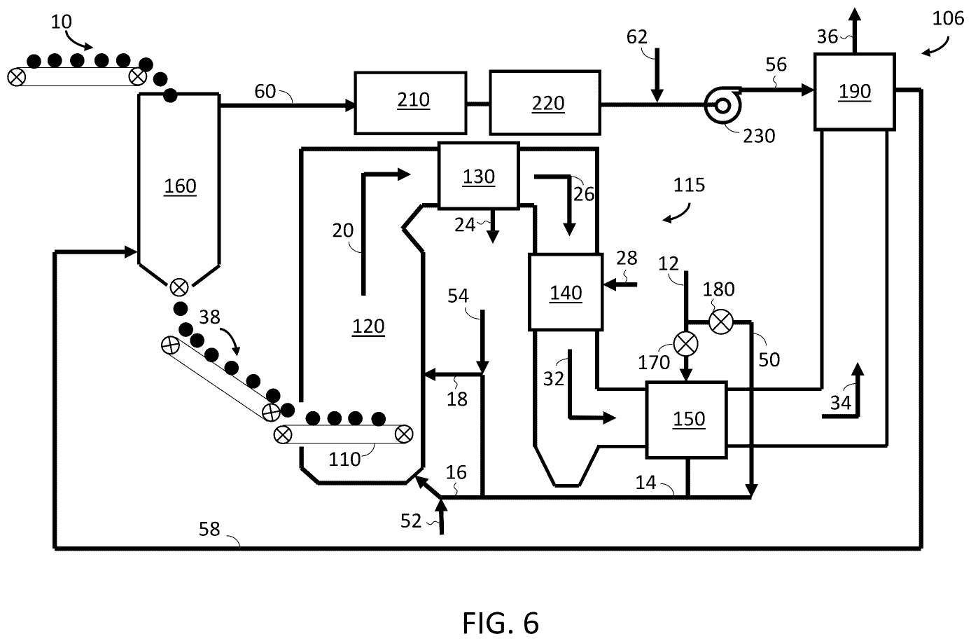

In contrast to the system 105 which includes a once-through flow of inert gas, the inert gas could be recycled as shown in FIG. 6 as a system 106. In order to recycle the moist inert gas stream 60, it may first be treated in a particulate removal unit 210, if needed. Further, water is removed from the moist inert gas stream 60 in a condenser 220 before being recompressed in a blower 230 to form the inert gas stream 56. An inert gas make-up stream 62 may be introduced anywhere along the loop, for example before the blower 230 as shown in FIG. 6. Oxygen enrichment via the primary oxygen-enriched stream 52 and/or the secondary oxygen-enriched stream 54 may optionally be included in the system 106.

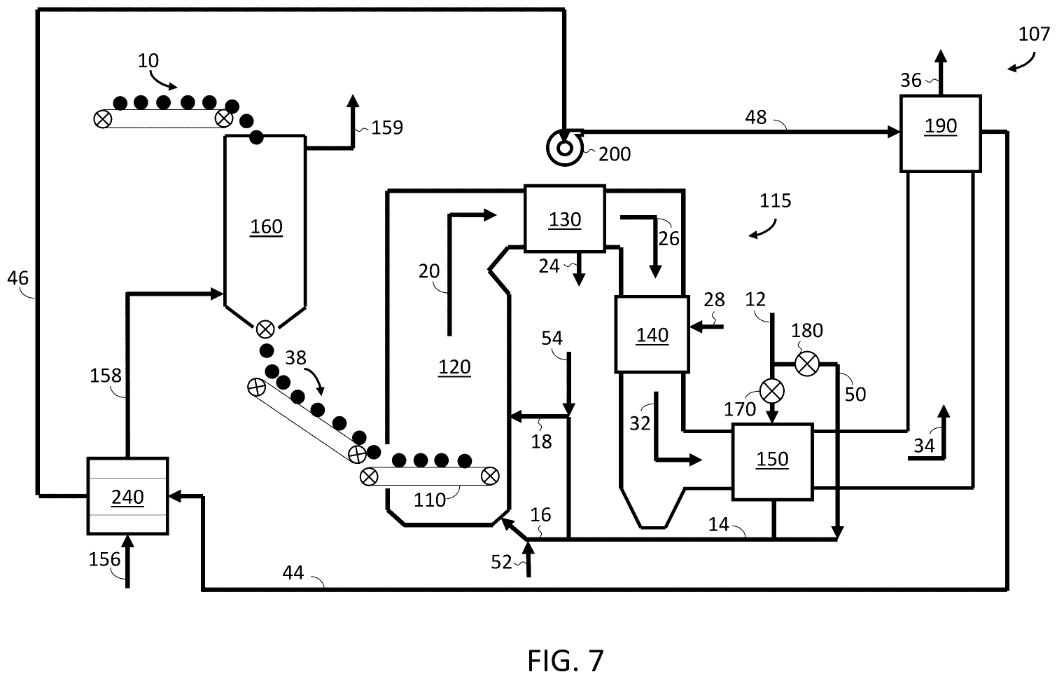

FIG. 7 illustrates a system 107 which can be considered a hybrid configuration that utilizes a first heat transfer fluid to heat a blanketing gas that, in turn, heats, dries and blankets the high moisture solid fuel 10 in the dryer 160, then exhausts evaporated moisture from the dryer 160. The system 107 includes a recirculating thermal fluid loop as in the system 102. However, in the system 107, the heated thermal fluid 44 indirectly transfers heat via a hybrid heat exchanger 240 instead of to the dryer 160. The hybrid heat exchanger 240 then heats an inert gas stream 156 to form a heated inert gas stream 158. Then, as in the system 105, the heated inert gas stream 158 dries the high moisture solid fuel 10 in the dryer 160 and exits the dryer 160 as a moist inert gas 159. The hybrid configuration can be useful when the dryer 160 is located a significant distance from the boiler 115 because over long distances a dense heat transfer fluid can be less expensive to circulate than an inert gas. Oxygen enrichment via the primary oxygen-enriched stream 52 and/or the secondary oxygen-enriched stream 54 is optional in the system 107.

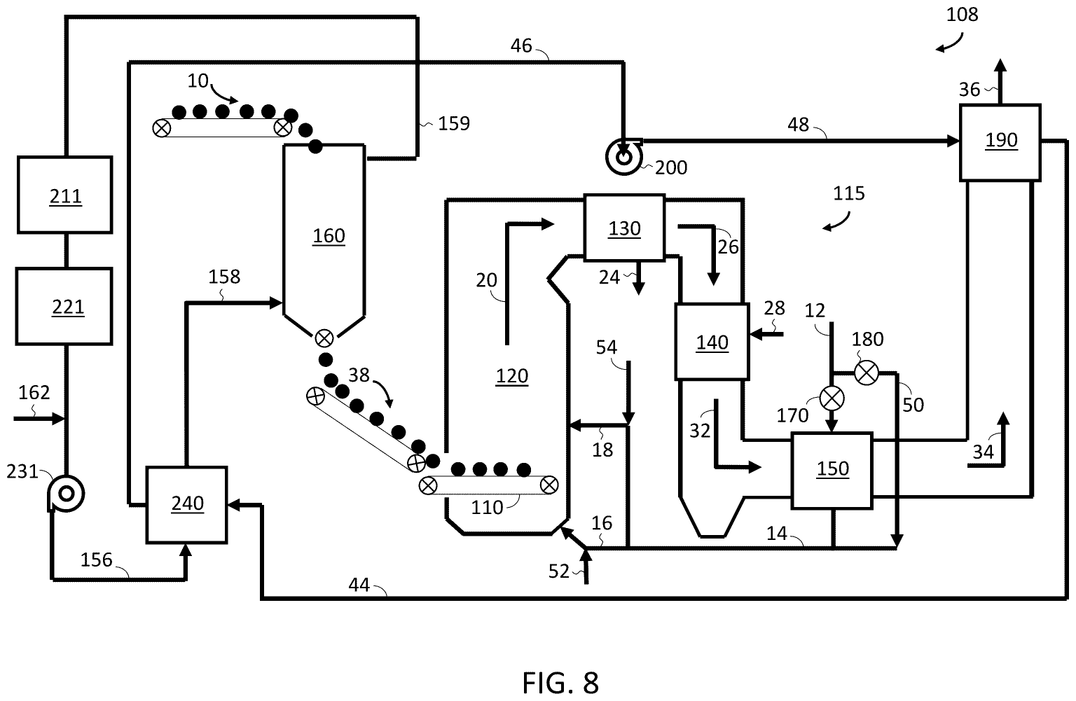

In the same way that the system 105 can be adapted for recycling the inert gas to create the system 106, the system 107 can be adapted for recycling the inert gas to create the system 108, as shown in FIG. 8. The system 108 introduces an optional particulate removal unit 211, a condenser 221, and a blower 231, to recycle the inert gas. Oxygen enrichment via the primary oxygen-enriched stream 52 and/or the secondary oxygen-enriched stream 54 is optional in the system 108.

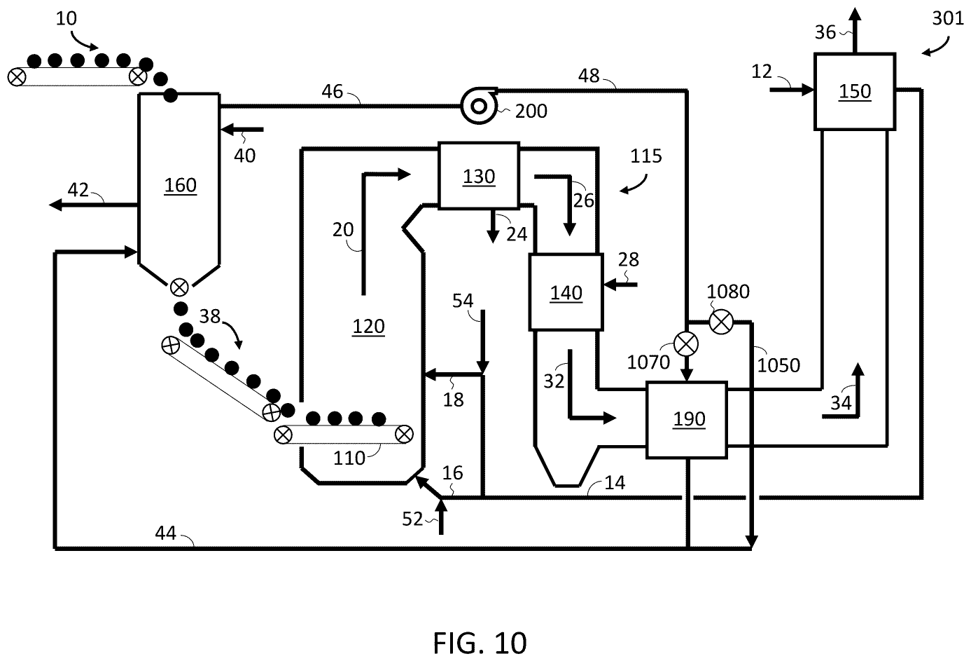

FIG. 10 is a flowsheet schematic depicting a modification of the embodiment of FIG. 2 in which the positions of an air preheater and an auxiliary heat exchanger are switched. In system 301, second cooled combustion products stream 32 transfers heat to pumped recirculating thermal fluid 48 in auxiliary heat exchanger 190. At least a portion of recirculating thermal fluid 48 may be bypassed around auxiliary heat exchanger 190 as auxillary bypass stream 1050 by use of control valves 1070 and 1080. Third cooled combustion products stream 34 leaves auxiliary heat exchanger 190 and enters air preheater 150 to transfer heat indirectly to air stream 12.

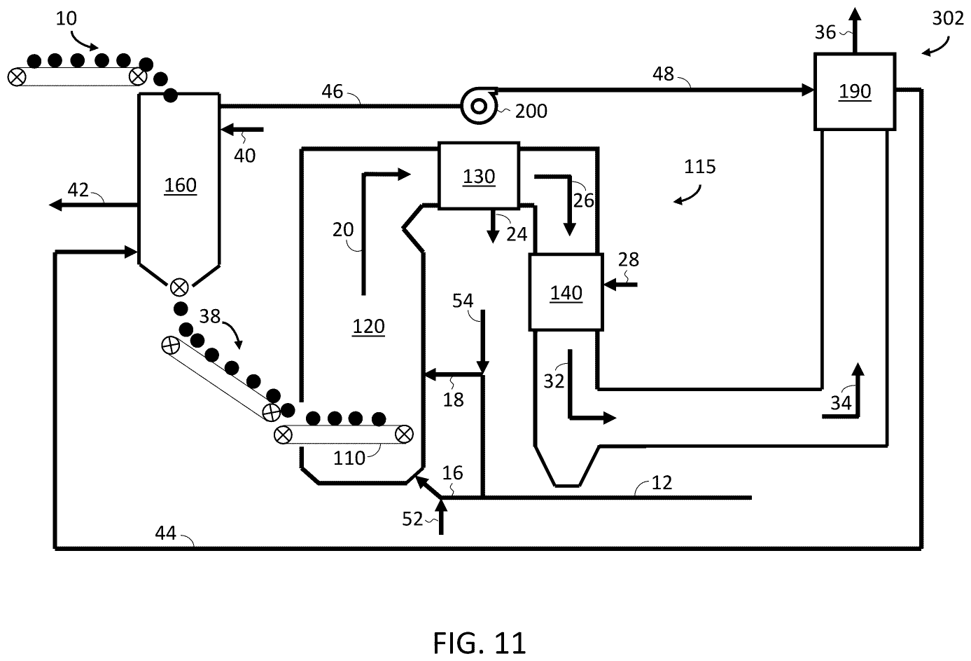

FIG. 11 is a flowsheet schematic depicting a modification of the embodiment of FIG. 2 in which the air preheater 150 is eliminated. Routing second cooled combustion products stream 32 to auxiliary heat exchanger 190 simplifies the operation of system 302.

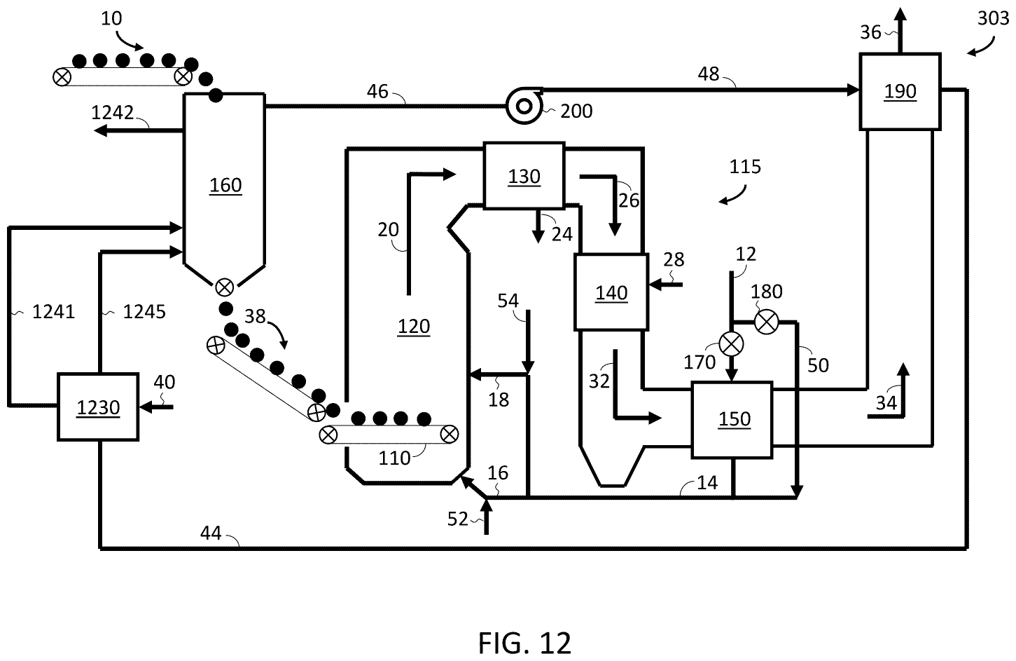

FIG. 12 is a flowsheet schematic depicting a modification of the embodiment of FIG. 2 especially advantageous for systems in which the dryer 160 relies on direct heat transfer from the blanketing gas to the wet solid fuel. In system 303, heated recirculating thermal fluid 44 may indirectly transfer heat to blanketing gas 40 in blanketing gas preheater 1230 to produce second heated recirculating thermal fluid 1245 and heated blanketing gas 1241. The heated blanketing gas 1241 may directly contact solid fuel 10 to remove moisture in dryer 160, exiting as moist blanketing gas 1242. The second heated recirculating thermal fluid 1245 may further drive the drying of high moisture solid fuel 10 by indirectly transferring heat to dryer 160, for example by flowing through a heated jacket.

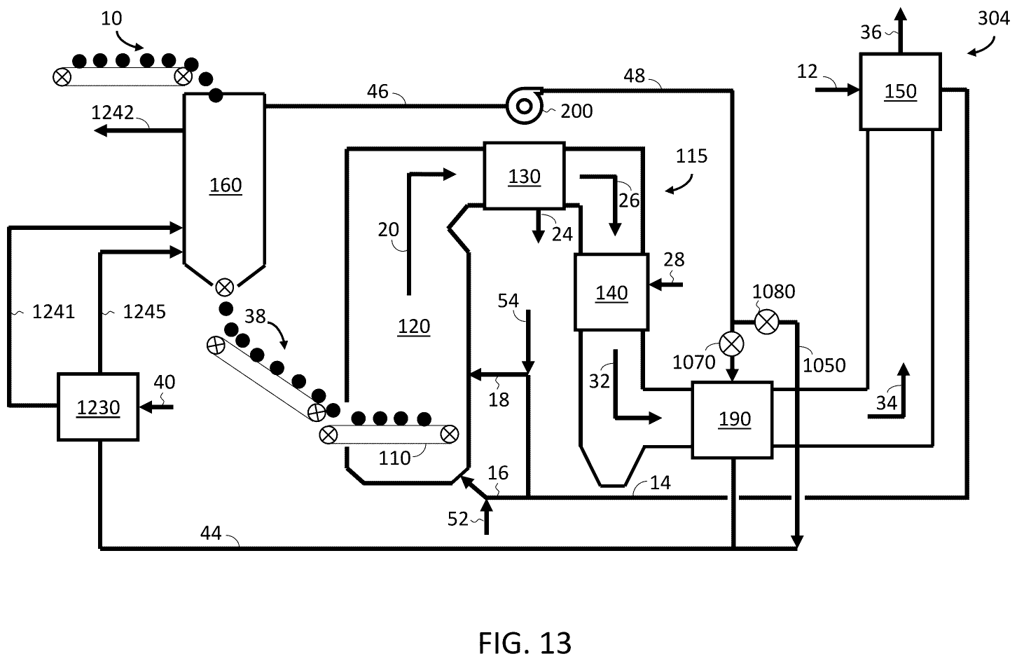

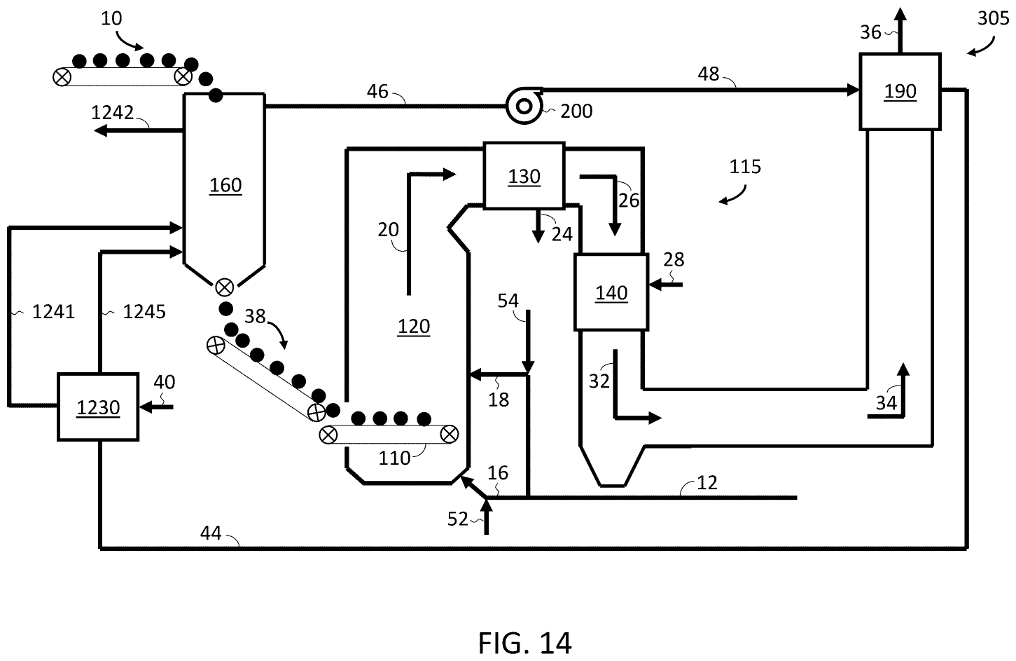

FIG. 13 is a flowsheet schematic depicting a modification of the embodiment of FIG. 10 in which a blanketing gas preheater allows direct heat transfer to the wet solid fuel, and FIG. 14 is a flowsheet schematic depicting a modification of the embodiment of FIG. 11 in which a blanketing gas preheater allows direct heat transfer to the wet solid fuel. In all of FIGS. 12-14 blanketing gas preheater 1230 may improve the operation of dryer 160 for systems in which the dryer 160 relies on direct heat transfer from the blanketing gas to the wet solid fuel.

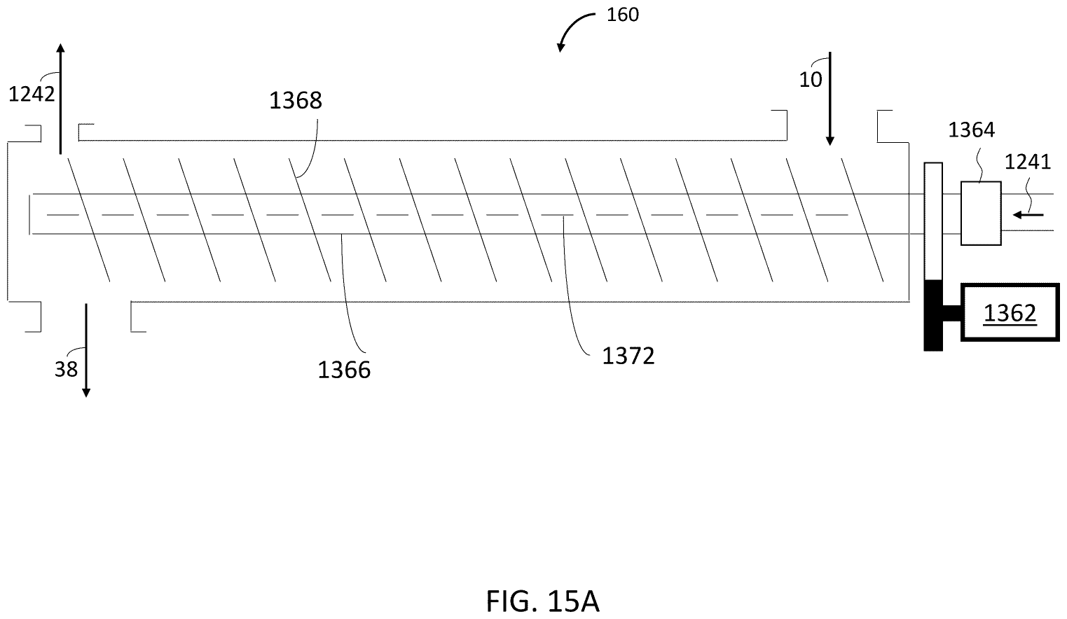

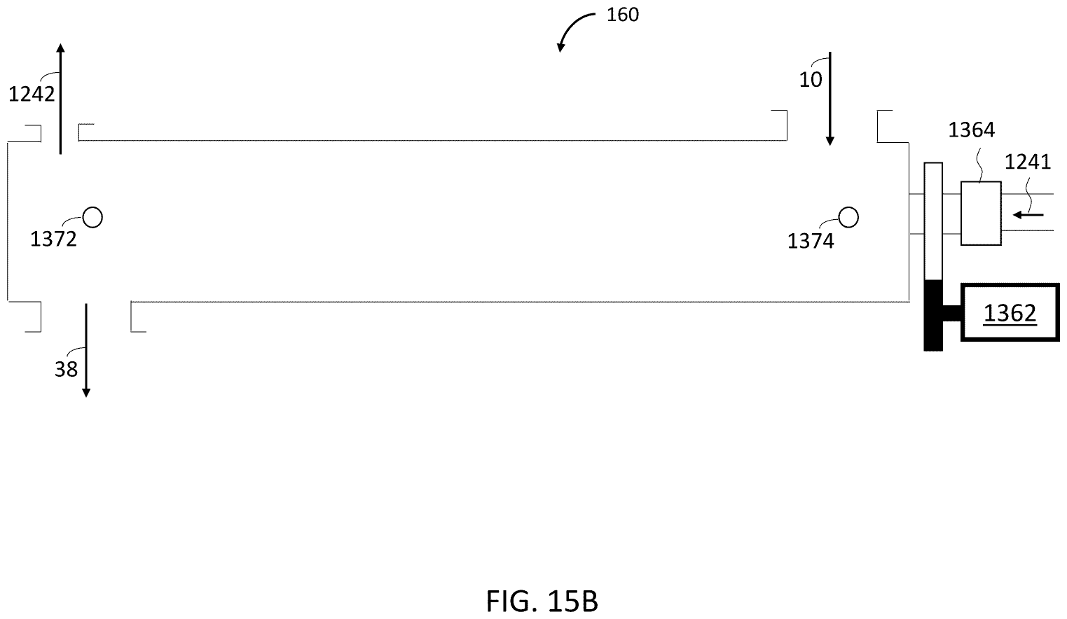

FIG. 15A is a cross-section showing an embodiment of a screw conveyor for drying a solid fuel. High moisture solid fuel 10 may enter the dryer 160 on the side of the screw conveyor near motor 1362. Heated blanketing gas 1241 may pass through a rotary coupling 1364 to enter a hollow screw shaft 1366. Hollow screw shaft 1366 may be fitted with a helical screw flight 1368 to push high moisture solid fuel 10 along the length of the screw conveyor. Heated blanketing gas 1241 may exit hollow screw shaft 1366 via one or more holes 1372 to directly contact high moisture solid fuel 10. In a preferred embodiment, holes 1372 are located at multiple points evenly distributed around the periphery of hollow screw shaft 1366. Moreover, it may further be advantageous to arrange groups of peripherally distributed holes 1372 at different axial locations along the hollow screw shaft 1366. It is yet further advantageous to maintain a balance between the minimum opening dimension of holes 1372 and the velocity of heated blanketing gas 1241 such that the velocity is sufficiently high to prevent back migration of small solid fuel particles into the center of the hollow shaft, yet low enough such that fluidization of the solid fuel does not occur during transport through the dryer, and, moreover, low enough such that sufficient time is provided for thorough heat and mass transfer between heated blanketing gas 1241 and high moisture solid fuel 10. It will be appreciated by those skilled in the art that such an optimal velocity or range of velocity will depend on factors such as solid fuel moisture content, size distribution, shape, surface area to volume ratio, density and the degree of compaction of the fuel particles between screw flights 1368. Such a complex series of relationships is not amenable to a priori determination and must be therefore be assessed empirically. At the discharge end of the screw conveyor dry solid fuel 38 and moist blanketing gas 1242 exit the dryer 160. Note that while solid fuel 38 and moist blanketing gas 1242 are shown discharging from different outlets of the screw conveyor, they may in fact share the same outlet if it is deemed to be advantageous for the system. This may be the case when dried solid fuel 38 must travel an appreciable distance prior to being discharged into the boiler, and therefore must remain in contact with the blanketing gas to prevent premature ignition during transit. The screw conveyor may be indirectly heated by second heated recirculating thermal fluid 1245, for example through a heated jacket. FIG. 15B shows an external view of the screw conveyor with inlet connection 1372 to accept second heated recirculating thermal fluid 1245 and outlet connection 1374 to output cooled recirculating thermal fluid 46. In at least some embodiments, the second heated recirculating thermal fluid flows counter-currently with respect to the movement of the high moisture solid fuel 10.

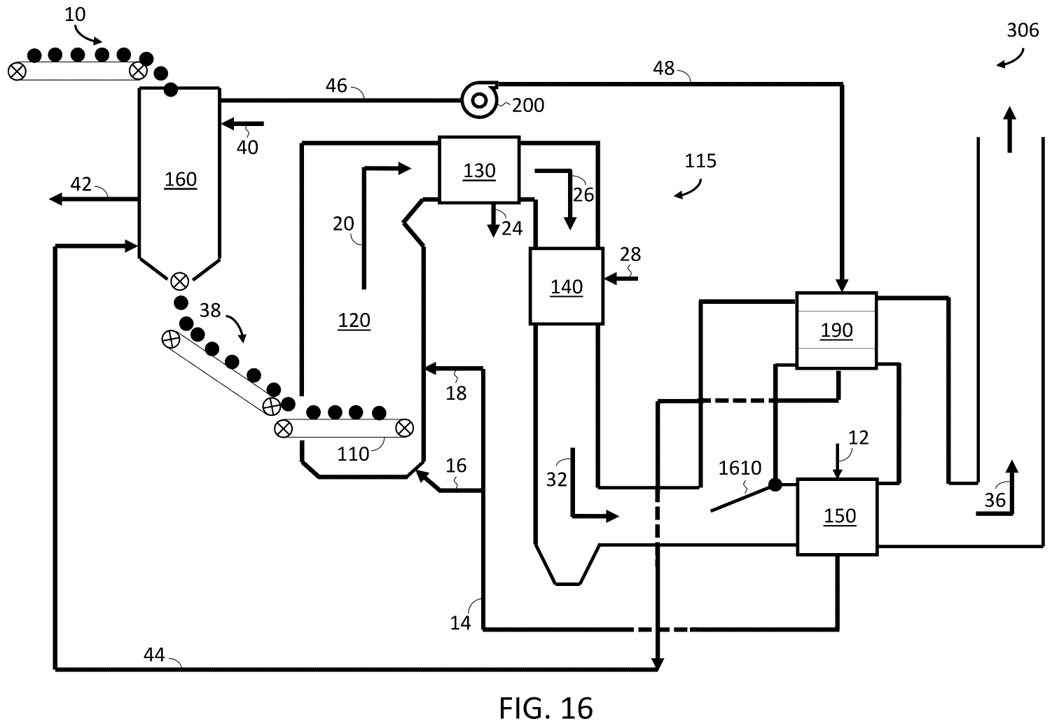

FIG. 16 is a flowsheet schematic showing a system configured such that the air preheater 150 and auxiliary heat exchanger 190 are arranged in parallel with respect to the oncoming flue gas flow. In system 306, second cooled combustion products stream 32 exits the economizer 140 and encounters a diverter 1610 that may divide the flow between a path comprising the air preheater 150 and a path comprising the auxiliary heat exchanger 190. The diverter 1610 may be configured to divide the flow in any proportion ranging from 100% of the flow to the air preheater 150 to 100% of the flow to the auxiliary heat exchanger 190. The diverter 1610 may for example comprise a splitter valve, two gate valves, two butterfly valves or any other suitable means for controlling the relative proportion of the flue gas flow rate directed to the air preheater 150 and auxiliary heat exchanger 190. Moreover, although not depicted as such in the figures, the diverter may be located at the downstream end of the air preheater 150 and auxiliary heat exchanger 190. Second cooled combustion products stream 32 may range in temperature from approximately 200° C. to 350° C. Dividing the flow using the diverter 1610 allows control of the split in the amount of heat between the air preheater 150 and auxiliary heat exchanger 190 while providing both with the highest quality heat available.

This embodiment may provide significant advantages to alternate embodiments for at least two reasons. Firstly, configuring the heat exchangers in parallel significantly reduces the flue gas pressure drop relative to the series configuration of the heat exchangers, thus reducing the fan power requirement and increasing fan flow capacity. Secondly, and perhaps more subtly, the parallel system approach is inherently more efficient for situations in which a process upset occurs. For example, consider the situation in which the operation of dryer 160 is interrupted. Hence, no heat is removed from the flue gas via auxiliary heat exchanger 190. In the parallel heat exchanger embodiment, the situation is promptly rectified by adjusting splitter damper to block flue gas flow to auxiliary heat exchanger 190 and divert it to air preheater 150. As such, thermal equilibrium of the cooled flue gas 36 is maintained throughout the upset. Now consider the same situation in the alternate embodiments represented in FIGS. 2, 3, 3A, 4, 4A, 5, 6, 7, 8, 11, 12 and 14. Flue gas 36 exiting the auxiliary heat exchanger 190 would be uncooled without dryer 160 acting as a heat sink. The higher flue gas temperature (and lower flue gas density) would substantially reduce boiler efficiency due to higher sensible heat loss while also increasing flue gas volume delivered to the induced draft fan and pollution control equipment (not shown) normally located between this point and the exhaust stack. The higher temperature and lower density flue gas flow stream entering the fan and pollution control equipment would render these devices much less efficient than in their normal condition in which the dryer 160 is in operation. And while the negative consequences of the upset are partially rectified by the embodiments shown in FIGS. 10 and 13, these embodiments nevertheless introduce a different problem, explained as follows. The highly undesirable flue gas 36 temperature elevation during the dryer upset condition could be avoided in FIGS. 10 and 13 by over-designing the air preheater 150 such that it is able to lower the temperature of flue gas 36 to a safe level during said dryer upset. However, in so doing, the temperature of flue gas 36 during normal (i.e. non-upset) operation would be much lower than desirable entering the induced draft fan, pollution control equipment and flue gas stack. This would result in condensation of condensable flue gas vapors such as water vapor and possibly sulfur or chlorine compounds, depending on fuel composition.

The condensation may result in corrosion and/or erosion of flue gas ductwork, induced draft fan blades and other flow path components, while also substantially reducing dispersion of the plume from the flue gas stack. It can thus be seen that only the embodiment of FIG. 16 avoids problems associated with operation in an upset state while also lower flue gas pressure drop which reduces fan power and thereby increases boiler efficiency. In some embodiments, the flue gas leaving the air preheater 150 and auxiliary heater 190 may not be recombined and a dedicated induced draft fan, pollution control equipment, and flue gas stack may be placed on both flue gas streams.

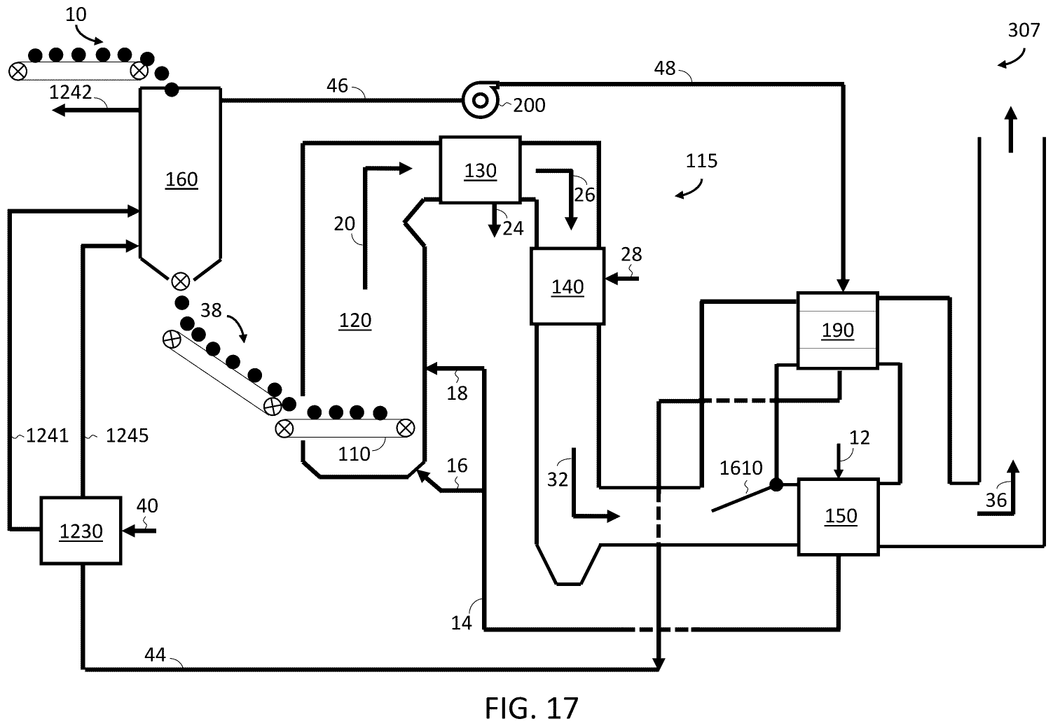

FIG. 17 is a flowsheet schematic depicting a modification of the embodiment of FIG. 16 in which a blanketing gas preheater allows direct heat transfer to the wet solid fuel. The dryer 160 may comprise a screw conveyor as shown in FIGS. 15A and 15B.

### Example 1

A fuel containing 50 wt % moisture enters a dryer at a rate of 20,000 kg/hr prior to entering a boiler. The process within the boiler requires that the incoming fuel moisture is reduced to 30 wt % prior to combustion. Heat for drying is available from the boiler flue gas at 200° C. The energy required to evaporate the fuel moisture is approximately:

$${Q}_{evap} = ( 0.5 - 0.3 ) \times 20 , 000 kg / hr \times 2250 kJ / kg \times 1 hr / 3600 sec = 2500 kW$$

where the latent heat of 2250 kJ/kg is based on an evaporation temperature of 90° C. Note that this estimate does not include the energy required to heat the water and solid fuel up to 90° C. Hence, the calculated energy transfer rate will be lower than actual, which is acceptable for the purpose of this illustrative example. Assuming dry nitrogen is the preferred blanketing gas, the mass flow rate of N₂ required to transfer this energy is:

$${M}_{N 2} = 2500 kW / [ 1.05 kJ / kg * K \times 110 ° C . ] = 21.7 kg / sec \sim 77 , 900 kg / hr = 1870 metric tonnes / day$$

which is nominally 20 times the mass of water being evaporated (M_{water}/M_{N2}˜0.05). Producing such a large quantity of dry nitrogen is economically prohibitive in many circumstances. However, as dry nitrogen at 90° C. can retain water vapor at a ratio of approximately M_{water}/M_{N2}˜1.44 at atmospheric pressure, this indicates a nitrogen requirement of only 67 metric tonnes/day would be required strictly from a mass transfer standpoint. Accordingly, in a preferred embodiment, dry nitrogen is used for fuel blanketing and capture/exhaust of evaporated moisture, while a heat transfer liquid such as any of a variety of commercially available thermal oils would be employed as the first heat transfer fluid.

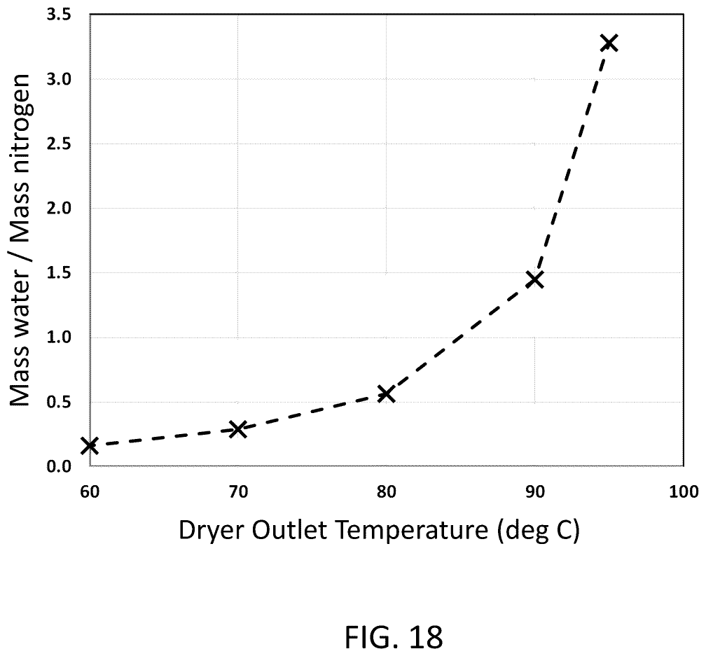

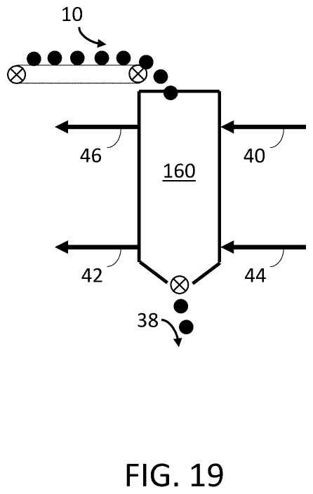

Example 1 shows that, in such an embodiment, it is advantageous to maintain the mass ratio of evaporated water to nitrogen, M_{water}/M_{N2}, as high as possible to minimize the amount of nitrogen (or other blanketing gas) required within the dryer. The challenge is in simultaneously ensuring that the water vapor content of the mixture does not exceed a relative humidity of 100%. As the saturated water vapor pressure increases sharply with temperature, this implies a relationship between the evaporated water to nitrogen ratio, M_{water}/M_{N2}, and the minimum nitrogen temperature leaving the dryer. Assuming ideal gas behavior, it can be shown that, for a saturated mixture of N2 and water vapor:

$${M}_{water} / {M}_{N 2} = 0.643 \times {P}_{water} ( T ) / [ {P}_{dryer} - {P}_{water} ( T ) ] \qquad ( 1 )$$

where P_{water}(T) is the saturation pressure of water as a function of temperature, and P_{dryer} is the operating pressure of the dryer. Assuming the dryer operates nominally at atmospheric pressure (1.013 bar) and employing the Clausius-Clapeyron equation to approximate the saturated water vapor pressure versus temperature relationship allows us to directly calculate the saturated water vapor to nitrogen mass ratio solely as a function of temperature. The results from such calculations, plotted in FIG. 18, indicate that the saturated water vapor to nitrogen mass ratio, M_{water}/M_{N2}, increases sharply as the temperature of the mixture is increased above 80° C. It is therefore highly preferred within this embodiment to operate the dryer with a nitrogen exit temperature of at least 80° C. Since fuel temperatures will increase within the dryer from ambient temperature at the inlet to the final fuel temperature leaving the dryer, it is therefore necessary within this embodiment for the dryer exit temperature to be at least 80° C. To prevent re-condensation of the evaporated moisture back to the fuel, it is further necessary that the evaporated water vapor/nitrogen mixture is exhausted from the dryer at a temperature of at least 80° C. One preferred method of achieving this latter condition is for the water vapor/nitrogen mixture to be exhausted from the dryer 160 at or near a fuel exit of the dryer 160 as depicted in FIG. 19. Typically streams are arranged in a counter-current arrangement for mass and/or heat transfer to maximize the driving force over the length of the unit operation. The heat transfer fluid 44, 46 flows counter-current to the high moisture solid fuel 10, as would be expected. However, in order to maximize the exit temperature of the moist blanketing gas 42, the blanketing gas 40 can be flowed counter-current to the heated recirculating thermal fluid 44 and co-current with the high-moisture solid fuel 10. The net result shows an unexpected benefit where the best mass transfer of moisture from the solid fuel to the oxygen-depleted gas stream is when they are flowing co-currently.

### Example 2

The embodiments of both the prior art boiler 115 of FIG. 1 and the system 104 of FIG. 4 were analyzed using the commercially available Aspen process modeling software. Properties of the as-received fuel (i.e., the high moisture content fuel 10) are presented in the Proximate and Ultimate fuel analyses shown in Tables 1 and 2, respectively. Results for the baseline system showing key performance metrics are summarized in Table 3. Note that the combustion equivalence ratio is used to define the amount of excess oxygen used for combustion. The equivalence ratio is defined as the actual fuel-to-oxygen ratio divided by the fuel-to-oxygen ratio theoretically needed to completely combust the fuel. Hence, a combustion process with equivalence ratio less than unity involves the use of excess oxygen molecules.

TABLE 1

| Parameter | Units | Value |
|---|---|---|
| Total as-Received Moisture Content | Wt % | 50 |
| Inherent Moisture Content | Wt % | 7.5 |
| Surface Moisture Content | Wt % | 42.5 |
| Ash Content | Wt % | 3.0 |
| Volatile Matter | Wt % | 38.4 |
| Fixed Carbon | Wt % | 8.6 |
| Higher Heating Value (HHV) | kJ/kg | 8991 |

TABLE 2

| Parameter | Units | Value |
|---|---|---|
| Carbon | Wt % | 23.58 |
| Hydrogen | Wt % | 3.24 |
| Oxygen | Wt % | 19.96 |
| Nitrogen | Wt % | 0.19 |
| Sulfur | Wt % | 0.02 |

TABLE 3

| Parameter | Units | Value |
|---|---|---|
| Fuel Flow Rate | Kg/hr | 21,355 |
| Steam Flow Rate | Kg/hr | 59,000 |
| Flue Gas Flow Rate | Kg/hr | 95,671 |
| Combustion Air Flow Rate | Kg/hr | 74,233 |
| Combustion Equivalence | N/A | 0.833 |
| Ratio | | |
| Flame Temperature | Deg C. | 1404 |
| Air Heater Gas Inlet | Deg C. | 234 |
| Temperature | | |
| Air Heater Gas Outlet | Deg C. | 160 |
| Temperature | | |
| Boiler Efficiency (HHV basis) | % | 74.6 |

Input parameters varied in the modeling effort include an air bypass flow rate, an air heater inlet gas temperature, an oxygen enrichment level, and a fuel flow rate, while key results comprise a rate of fuel moisture evaporation occurring in the dryer (as represented by the as-fired fuel moisture content), boiler efficiency, flame temperature, a flue gas flow rate, and a steam flow rate. It was assumed that the flue gas flow rate could not be increased above the baseline value and, to minimize flue gas condensation, the stack temperature could not be lowered beneath 70° C. A final assumption was that unburned carbon loss due to combustion inefficiency could be neglected. While this is not the case, especially with high moisture fuels, prediction methods for unburned carbon energy loss are not sufficiently accurate for results to be included in this disclosure. Hence, the more complete combustion that would be expected to occur with fuel drying is herein neglected.

Four cases will be considered for Example 2, distinguished by the temperature of the second cooled combustion products stream 32 and the flow of the combustion air bypass stream 50 as a percentage of the air stream 12. The four cases are listed in Table 4. The base case, Case 1, has the lowest temperature combustion products stream entering the air preheater 150, then in Cases 2 through 4 the combustion air bypasses the air preheater 150 and then the temperature of the second cooled combustion products stream 32 increases to 280 and 350° C. Effectively as the examples progress from Case 1 to Case 4, the amount of heat energy available to the auxiliary heat exchanger increases, allowing more of the heat of combustion to be used for drying the fuel.

TABLE 4

| Case | Stream 32 T (° C.) | Stream 50 Flow/Stream 12 Flow |
|---|---|---|
| 1 | 234 | 0% |
| 2 | 234 | 100% |
| 3 | 280 | 100% |
| 4 | 350 | 100% |

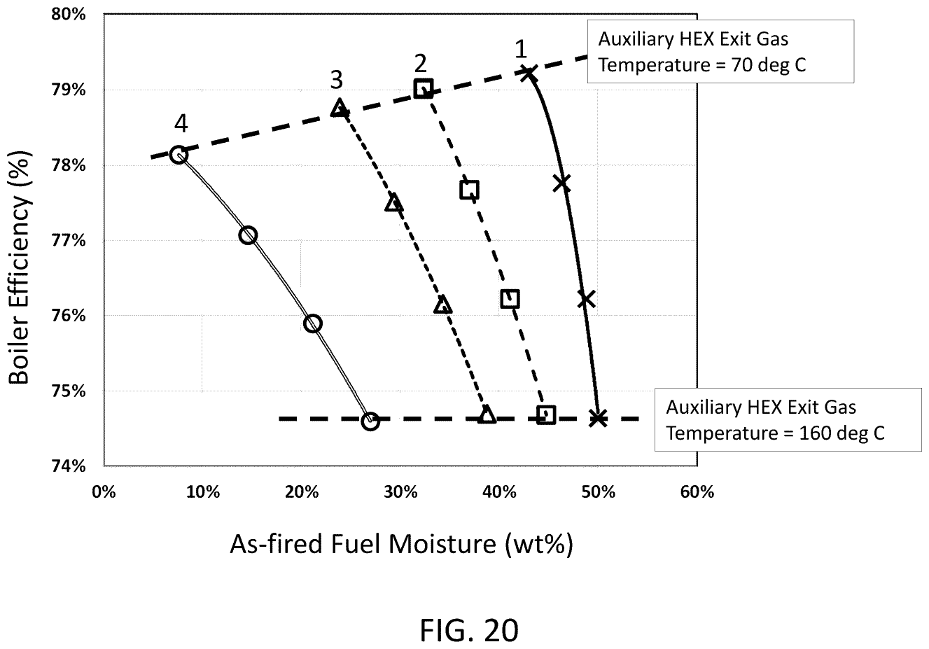

FIG. 20 plots boiler efficiency as a function of as-fired moisture content for the dried solid fuel 38 for the four cases listed in Table 4. All results correspond to a baseline steam generation rate of 59,000 kg/hr as can be seen in Table 3. Each curve traces the efficiency for a given case as the temperature of the exhaust gas 36 leaving the auxiliary heat exchanger 190 decreases until it reaches the practical lower limit of 70° C. below which there is too much risk of condensation. As one travels up each curve it can be thought of as increasing the auxiliary heat exchanger area, which both increases the amount of heat delivered to the dryer 160 and reducing the as-fired fuel moisture and increases the boiler efficiency. Moving from Case 1 to Case 4 further increases the heat transferred to the dryer 160, reducing the as-fired fuel moisture. It should be noted that the model does not take into account unburned carbon which would decrease as as-fired fuel moisture decreases, improving efficiency. Lower as-fired fuel moisture also would improve efficiency by increasing temperature in the furnace section 120 of the boiler 115, which is also not accounted for in the model.

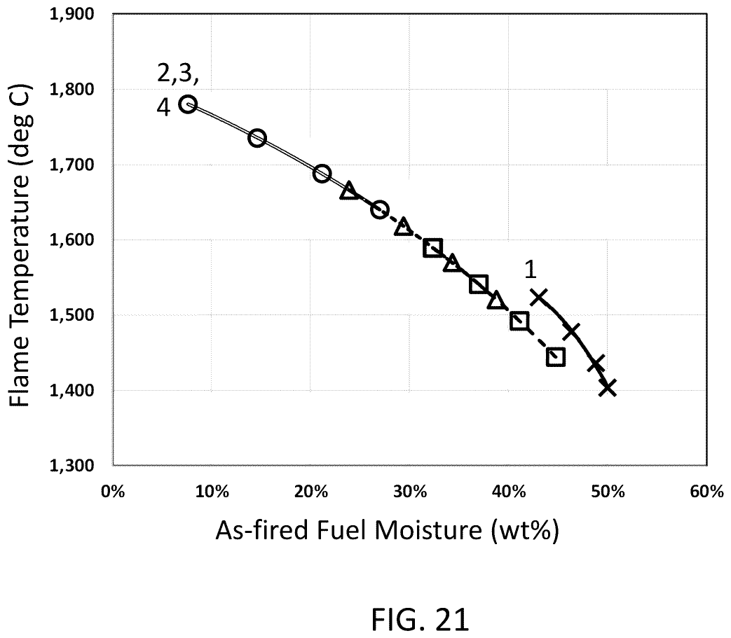

FIG. 21 plots flame temperature versus as-fired fuel moisture for the same four cases. The dramatic increase in flame temperature with decreasing fuel moisture is beneficial for two distinct reasons. First, the higher temperatures increase the rate of radiation heat transfer from the flame to the boiler water tubes in the radiant section of the boiler, thus reducing the surface area required to raise the same amount of steam. Secondly, the higher flame temperature increases the rate of chemical reactions, minimizing unburned carbon losses. Note that the curves of Cases 2, 3 and 4 collapse to form a single temperature curve that is slightly lower than the curve of Case 1. This is because Case 1 is the only case where the combustion air stream 14 is preheated; all other cases utilize ambient temperature combustion air. Hence, flame temperature for Case 1 is moderately higher for a given as-fired fuel moisture level than the other 3 cases.

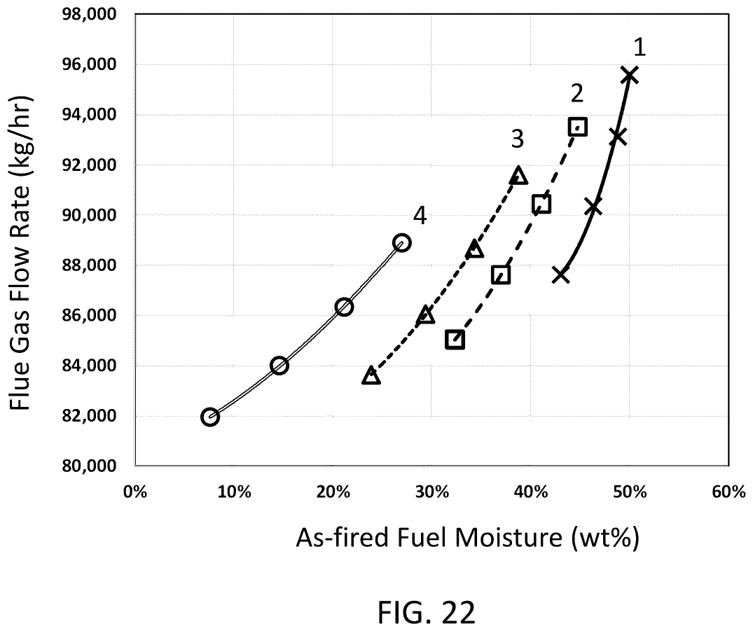

FIG. 22 plots flue gas flow rate versus as-fired moisture content, again for the same four cases. Note the sharp decrease in flue gas flow with decreasing fuel moisture. This large effect is due to two causes; one is the reduction in flue gas moisture content and the other is the simultaneous increase in boiler efficiency, which reduces the required fuel flow rate. As a boiler is optimally designed to handle a fixed flue gas volume due to constraints including heat exchangers, pressure drop, and pollution control equipment, this large reduction in flue gas volume can be leveraged in one of two ways. The first option would be to reduce the size of the boiler for a fixed steam generation rate, and the second would be to maintain the same boiler size and baseline flue gas flow rate while increasing fuel flow and/or thermal energy input to increase the steam generation rate.

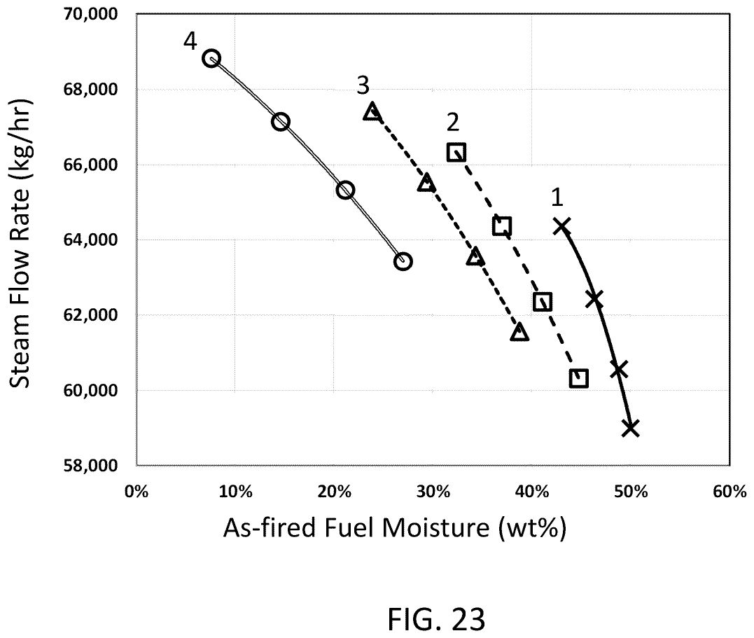

FIG. 23 illustrates the second option, in which for a given boiler size, the steam flow rate is plotted as a function of as-fired fuel moisture level. The increase in product steam as the degree of drying increases illustrates the value of the current invention, in which using heat energy to dry the high-moisture solid fuel instead using it to preheat the combustion air or to heat water in the economizer increases the steam production for a given boiler size. Case 4 being the best option is unexpected when as can be seen in FIG. 20, Case 1 results in the highest boiler efficiency, and as can be seen in FIG. 21, Case 1 traces a higher flame temperature for a given as-fired fuel moisture level.

### Example 3

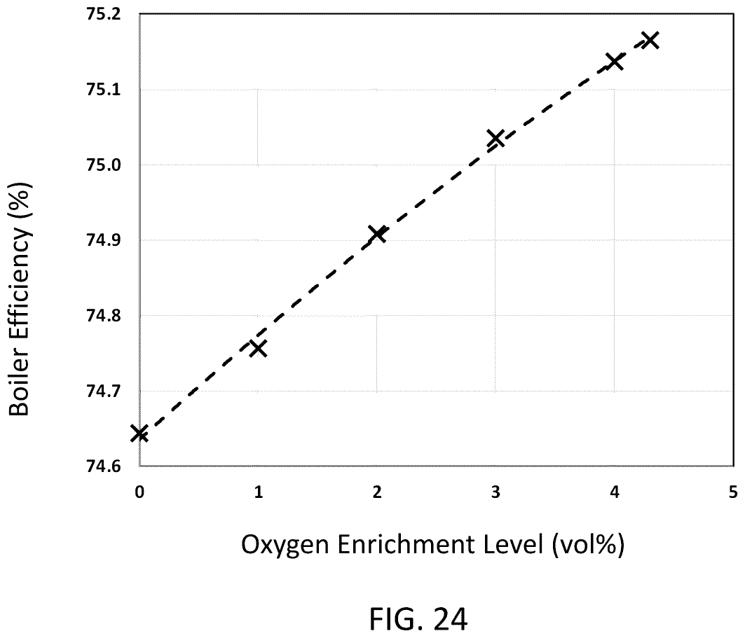

Introduction of oxygen into the combustion system further expands the boiler performance benefits highlighted in Example 2. Using oxygen-enriched combustion air while maintaining the same combustion equivalence ratio as in the baseline case leads to a higher flame temperature and faster chemical kinetic rates resulting in higher rates of radiant heat transfer and higher combustion efficiency with lower unburned carbon losses. Moreover, the reduction of nitrogen in the combustion air lowers the combustion products flow rate which, in turn, further augments the boiler's steam generation rate, as previously explained. As the unburned carbon losses are unaccounted for in the model, the improvement in boiler efficiency due to oxygen enrichment calculated by the model and plotted in FIG. 24 is solely a function of the reduced combustion products flow rate and is therefore under-predicted. Note that oxygen enrichment level is herein defined as the difference in volumetric (or molar) oxygen concentration of the mixture of combustion air stream 12, primary oxygen-enriched stream 52, and secondary oxygen-enriched stream 54 minus the ambient oxygen concentration of 20.9%. So, for example, an oxygen enrichment level of one percent corresponds to a mixed oxidizer concentration of nominally 21.9% by volume.

In principal, the oxygen concentration selected for the combustion system can be chosen independently of other equipment considerations within the overall systems described herein. However, in a preferred embodiment, the oxygen and nitrogen supplies for the system are produced by a single air separation unit. As such, the oxygen enrichment flow rate is coupled to the nitrogen flow rate used within the fuel dryer.

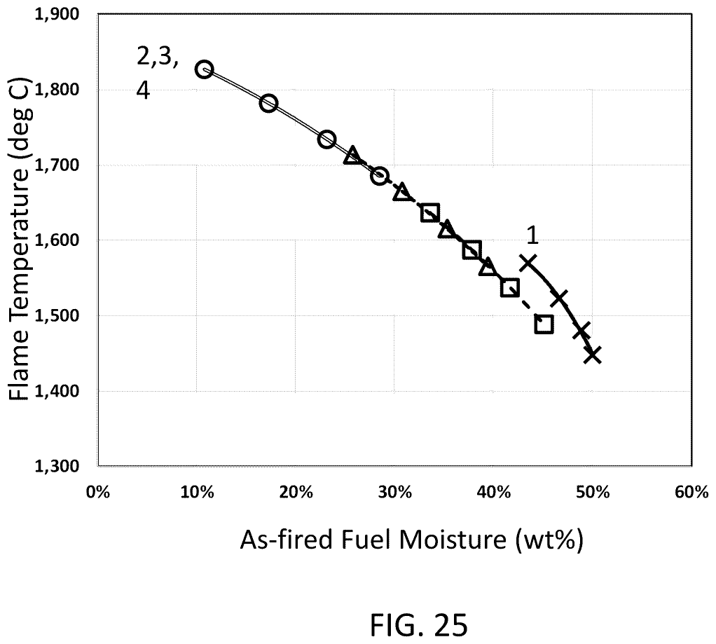

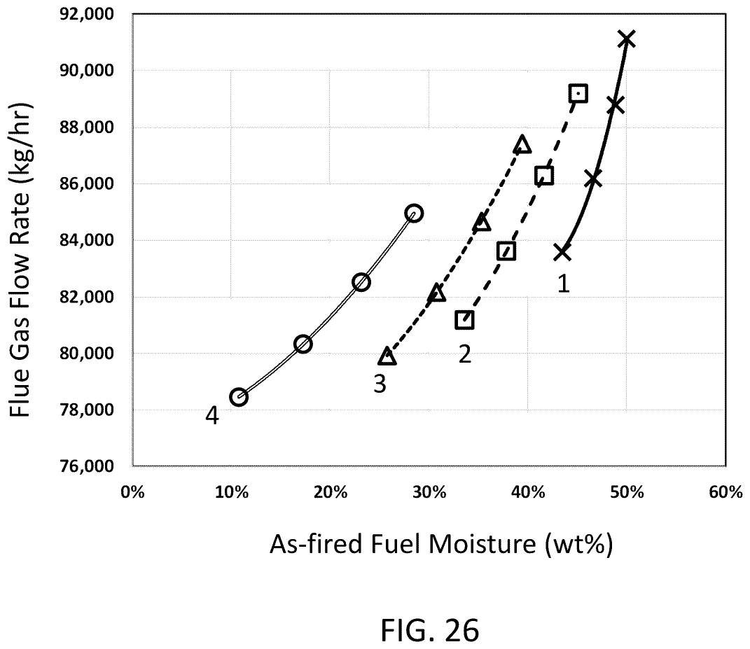

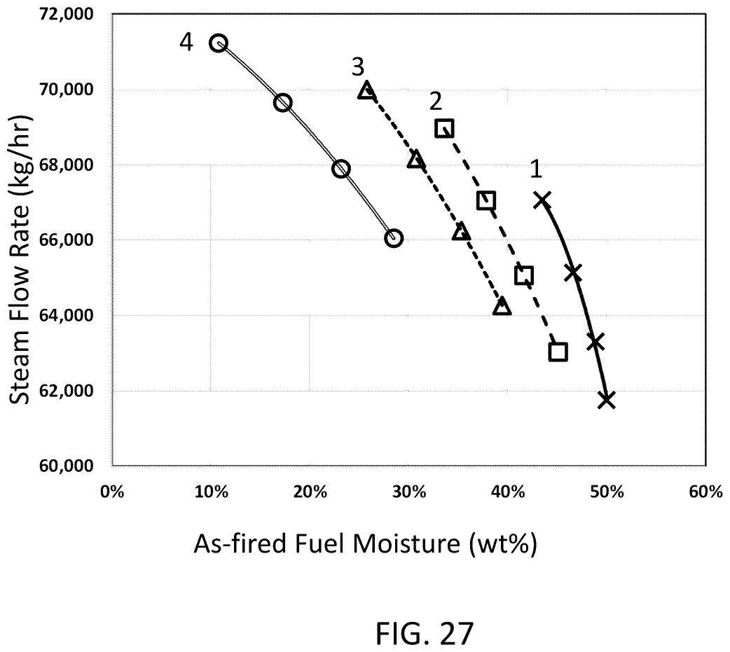

Example 3 assumes the same as-received coal properties as in Tables 1 and 2 and the analogous cases as in Example 2, and considers a dryer temperature of 95° C. and a maximum fuel moisture evaporation rate of 8500 kg/hr. From FIG. 10, the ratio of evaporated water to nitrogen is approximately 3.3. Hence, the nitrogen flow rate selected for the system is 8500/3.3˜2575 kg/hr. Accordingly, the oxygen flow rate would typically be between about 770 to 1290 kg/hr, and the corresponding oxygen enrichment level of the air between about 1.0 to 1.5 vol %. Selecting an enrichment level of 1.3%, which is in this range, FIGS. 25, 26 and 27 summarize, respectively, the model predictions of flame temperature, flue gas flow rate and increased steam temperature vs as-fired fuel moisture. Comparing FIG. 25 with FIG. 21, the oxygen enrichment level of 1.3% increased the flame temperature by 50° C. beyond that attained with drying. In practice this would lead to an incremental increase in boiler radiant heat transfer and reduction in unburned carbon loss. Comparing FIG. 26 with FIG. 22 indicates an incremental reduction in flue gas volume of 4000-5000 kg/hr due to the oxygen enrichment at the baseline steam generation rate of 59,000 kg/hr. Finally, leveraging this reduced flue gas volume per unit of fuel flow to generate more steam, FIG. 27 reveals an incremental steam generation rate of nominally 2500 kg/hr higher than that produced without oxygen as shown in FIG. 23.

A final feature and benefit of the systems described herein is the ability to continuously adapt the system performance to variations in incoming fuel properties. For example, changes in as-received fuel moisture content or heating value may require adjustment to the degree of fuel drying. Or, a change in fuel ash properties may suggest the need to lower or increase the flame temperature. It will be readily appreciated based on the foregoing system description and analyses that optimal boiler operation in response to these and other changes in fuel properties are enabled by adjustment to the air heater bypass and/or oxygen enrichment level. To that end, proper system response to fuel property variations may require associated measurement instrumentation including one or more of the following performance parameters: fuel moisture level of the high-moisture solid fuel 10, fuel moisture level of the dried solid fuel 38, temperature of the boiler grate 110 (when the boiler is a stoker boiler), and temperature(s) of the combustion products stream 20, the first cooled combustion products stream 26, the second cooled combustion products stream 32, the third cooled combustion products stream 34, as well as steam temperature and steam pressure.

The output of one or more of these instruments may be connected in a control loop to automatically adjust the air heater air bypass damper position and/or the oxygen flow rate until a setpoint value is attained, similar to the control loops shown in the systems 103A and 104A.

While the principles of the invention have been described above in connection with preferred embodiments, it is to be clearly understood that this description is made only by way of example and not as a limitation of the scope of the invention.

1. A process for combusting a high-moisture fuel to generate steam, the process comprising:
heating a high-moisture solid fuel while contacting the high-moisture solid fuel with an oxygen-depleted gas stream to produce a dried solid fuel and a moist oxygen-depleted gas stream;
combusting the dried solid fuel with a combustion air stream to produce a combustion products stream;
transferring heat to generate steam by indirect heat exchange with the combustion products stream;
dividing the combustion products stream into a first portion and a second portion;
transferring heat to the recirculating thermal fluid by indirect heat exchange with the first portion of the combustion products stream;
and transferring heat to preheat the combustion air stream by indirect heat exchange with the second portion of the combustion products stream; and
recombining the first portion of combustion products stream and the second portion of the combustion products stream.

2. The process of claim 1, wherein a diverter controls the flow rates of the first and second portions of the combustion products stream.

3. The process of claim 1, further comprising adding an oxygen-enriched stream to the combustion air stream prior to combusting the dried solid fuel; and
controlling one or both of a flow rate of the oxygen-enriched stream and a location of adding the oxygen-enriched stream to control one or more of the following properties: steam temperature, steam pressure, steam drum level, stoker grate temperature, temperature of the combustion products stream prior to transferring the first portion of the amount of heat to generate steam, temperature of the combustion products stream after transferring the first portion of the amount of heat to generate steam, temperature of the combustion products stream after transferring the second portion of the amount of heat to the recirculating thermal fluid, temperature of the combustion products stream after transferring the third portion of the amount of heat to preheat the combustion air, temperature of the moist oxygen-depleted gas stream, temperature of the dried solid fuel, moisture level of the high-moisture solid fuel, and moisture level of the dried solid fuel.

4. The process of claim 1, further comprising transferring heat from the recirculating thermal fluid to the oxygen depleted gas stream before it contacts the high moisture solid fuel to produce a heated oxygen depleted gas stream.

5. The process of claim 4, wherein the heated oxygen-depleted gas stream is contacted with the high-moisture solid fuel within a screw conveyor.

6. The process of claim 5, wherein the screw conveyor comprises a hollow rotating shaft with one or more holes; and
wherein the heated oxygen-depleted gas stream passes radially outward through the one or more holes to contact the high-moisture solid fuel.

7. The process of claim 1, wherein the high-moisture solid fuel is contacted with the oxygen-depleted gas stream while heating the high-moisture solid fuel by indirect heat exchange with the recirculating thermal fluid to produce the dried solid fuel and the moist oxygen-depleted gas stream.

8. An apparatus for generating steam comprising:
a dryer configured and arranged to create contact between a high-moisture solid fuel and an oxygen-depleted gas stream and to produce a dried solid fuel;
a combustion air system having an air inlet for receiving air and a combustion air outlet for discharging the combustion air stream;
a boiler comprising a furnace section, a convective section, and an energy recovery section,
the furnace section being configured to receive the dried solid fuel from the dryer and the combustion air stream from the combustion air system, and to combust the dried solid fuel with a combustion air stream to produce a combustion products stream, and transferring heat from the combustion products stream to boil water principally by thermal radiation,
the convective section having one or more heat exchangers in fluid flow communication with the furnace section for transferring heat to boil water principally by convection heating, and
the energy recovery section comprising a diverter configured to divide the flow of the combustion products stream between a first flue path and a second flue path, wherein the first flue path comprises an air preheater for preheating the combustion air stream by indirect heat exchange with a portion of the combustion products stream, and wherein the second flue path comprises an auxiliary heat exchanger for heating a first heat transfer fluid.

9. The apparatus of claim 8, the dryer having an inlet section and an outlet section, the inlet section including a high-moisture solid fuel inlet, an oxygen-depleted stream inlet, and a recirculating thermal fluid outlet; the outlet section including a high-moisture solid fuel outlet, an oxygen-depleted stream outlet, and a recirculating thermal fluid inlet.

10. The apparatus of claim 8, the combustion air system further having an oxygen inlet for receiving oxygen and one or more oxygen control valves to enable controlled oxygen enrichment of the combustion air stream upstream of the combustion air outlet.

11. The apparatus of claim 8, wherein the dryer comprises a screw conveyor comprising a high-moisture solid fuel inlet, and a hollow screw shaft fitted with a helical screw flight configured to push the high-moisture solid fuel along the length of the screw conveyor;
a blanketing gas preheater configured to indirectly transfer heat from the first heat transfer fluid to the oxygen-depleted gas stream to produce a heated oxygen-depleted gas stream;
wherein the hollow screw shaft comprises one or more holes in fluid flow communication with the heated oxygen-depleted gas stream.

12. A system for drying a high-moisture solid fuel comprising:
a screw conveyor comprising a high-moisture solid fuel inlet, and a hollow screw shaft fitted with a helical screw flight configured to push the high-moisture solid fuel along the length of the screw conveyor;
wherein the hollow screw shaft comprises one or more holes in fluid flow communication with a source of blanketing gas.

13. The system of claim 12, further comprising:
a combustion air system having an air inlet for receiving air and a combustion air outlet for discharging a combustion air stream;
a boiler comprising a furnace section, a convective section, and an energy recovery section,
the furnace section being configured to receive the dried solid fuel from the screw conveyor and the combustion air stream from the combustion air system, and to combust the dried solid fuel with the combustion air stream to produce a combustion products stream, and transferring heat to boil water principally by thermal radiation, the convective section having an auxiliary heat exchanger in fluid flow communication with the furnace section for transferring heat from the combustion products stream to boil water, and
the energy recovery section comprising an air preheater for preheating the combustion air stream by indirect heat exchange with the combustion products stream, and an auxiliary heat exchanger for heating a first heat transfer fluid.

14. The system of claim 13, wherein the screw conveyor comprises a heat exchanger in fluid flow communication with the auxiliary heat exchanger.

15. The system of claim 13, further comprising a blanketing gas preheater for preheating the blanketing gas by indirect heat exchange with the first heat transfer fluid.

16. The system of claim 13, wherein the energy recovery section comprises a diverter upstream of the air preheater and the auxiliary heat exchanger, the diverter configured to divide the flow of the combustion products stream between a first flue path comprising the air preheater and a second flue path comprising the auxiliary heat exchanger.

17. The system of claim 12, wherein the screw conveyor comprises a heat exchanger in fluid flow communication with an auxiliary heat exchanger.

18. The system of claim 12, further comprising a blanketing gas preheater for preheating the blanketing gas by indirect heat exchange with a first heat transfer fluid.
